(19) United States
(12) Patent Application Publication
(10) Pub. No.: US 2013/0218829 A1
(43) Pub. Date: Aug. 22, 2013

(54) DOCUMENT MANAGEMENT SYSTEM AND METHOD

(71) Applicant: Deneen Lizette Martinez, Bogota, NJ (US)

(72) Inventor: Deneen Lizette Martinez, Bogota, NJ (US)

(21) Appl. No.: 13/834,483

(22) Filed: Mar. 15, 2013

(51) Int. Cl. G06F 17/30

(52) U.S. Cl. CPC G06F 17/30165
USPC 707/608

(57) ABSTRACT

A document management system/method allowing coordinated synchronized modifications and secure, scalable, multi-level, and controlled access to Data Content and/or Documents (DCDS) over a computer network between multiple Content Owners and/or Reviewers (CORS) is disclosed. The system/method is configured to allow any number of CORS to share DCDS using a Content Collaboration Platform (CCP) while retaining complete DCDS integrity/retrieval control using a hierarchical Access Rights and Control List (ARCL) to prevent CORS from uncoordinated DCDS modification and prohibiting local maintenance of DCDS copies after the expiration of a CORS Data Access Session (DAS). Upon termination of a CORS DAS, the system synchronizes modifications to the DCDS and coordinates control information among various CORS to ensure proper return of the DCDS back to its original CORS owner and associated CORS storage location.

### CROSS REFERENCE TO RELATED APPLICATIONS

Not Applicable

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

Embodiments of the present invention generally relate to distributed computing systems and, more particularly, relates to systems, methods, and articles of manufacture for synchronizing document management over computer networks. While not limitive of the invention teachings, the present invention may in some circumstances be advantageously applied to categories including U.S. Patent Classifications 715/750-759 and 715/700.

### PRIOR ART AND BACKGROUND OF THE INVENTION

### Overview

The ubiquity and versatility of the Internet continues to spur the development of information management applications. Software products such as Dropbox®, BOX, and OpenText Tempo™ provide users with the ability to save and share documents in a Web (cloud) based storage container where they and other invited users can access these documents. In such products, a user may select and copy a document from storage locations on their local computer or network to a container located on the Web, where they can later access it from any device over the Internet or share it with others.

In such products, a separate and external content and/or document repository is created outside of the local computer or a company's centrally managed and corporate governance regulated repository, namely document management systems (DMS) and/or enterprise content management systems (ECM) such as eDocs, Worksite, Worldox GX3, NetDocuments, SharePoint, Documentum, and FileNet in order to be accessed from any device over the Internet or shared with others.

While such products provide remote access to documents, they do not provide enough versatility and security needed for sharing information on the Internet. For example, conventional systems do not allow for the option for a document creator and owner to send to a content reviewer or collaborator a link to a document that allows a reviewer or collaborator limited access to the document during a session with the Web-based service. Nor do such systems prevent the reviewer or collaborator from maintaining a copy of the document after the session ends. Such systems further do not offer options for collaborating project folders that offer reviewer specific access to documents within the folders.

Accordingly, there is a need for a system and method that provides the benefits of a Web-based document management system that offers controlled access to documents over a network and synchronizing modifications to those documents and other information between document owners and content reviewers back into the original storage location.

### Deficiencies in the Prior Art

While the prior art as detailed above is currently used to manage documents over a computer network, this prior art suffers from the following deficiencies:
Prior art document management systems do not allow for content control. These systems allow for the creation of unmanaged data and/or content outside of a company's knowledge and control.
Prior art document management systems do not allow for a central point of reference. These systems allow for the creation of a separate content repository outside of a company's content and/or document management strategy.
Prior art document management systems do not prevent a loss of content custody for the content owner. These systems cannot restrict reviewers from gaining custody of any or all of the content being shared by the owner.
Prior art document management systems do not avoid version proliferation. These systems cannot control the creation of multiple versions of a document saved to different locations.
Prior art document management systems do not manage and retain edit history of a document. These systems do not retain history about the document lifecycle, such as who has edited, viewed, copied, or printed a document.
Prior art document management systems do not adhere to audit and compliancy regulations. These systems do not follow internal audit compliances to ensure that operating procedures adhere to laws and corporate policies.

To date the prior art has not fully addressed these deficiencies.

### OBJECTIVES OF THE INVENTION

Accordingly, the objectives of the present invention are (among others) to circumvent the deficiencies in the prior art and affect the following objectives:
(1) Provide for a document management system and method that allows for sharing information regardless of where the information is located.
(2) Provide for a document management system and method that provides a single consolidated content and/or document library view which draws from multiple document library stores.
(3) Provide for a document management system and method that allows all parties to work in a controlled environment that enables collaboration, version control and prevents leakage of information.
(4) Provide for a document management system and method that adheres to corporate governance policies and does not store data outside the safety of a company's managed systems.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

### System Overview (0100)

The present invention in various embodiments implements a document management system incorporating a Content Collaboration Platform (CCP). The CCP is a web-based portal that allows content owners to share a variety of information, such as documents, emails, legal research, news articles, etc., with one or more content reviewers for the purposes of review and collaboration. The CCP contains an approval engine that allows content owners (“clients”) to initiate an approval workflow for any document once the collaboration process has been completed. The CCP implements a secure data exchange environment where all of the content is served up in virtual memory and is then removed when a Data Access Session (DAS) is completed to prevent any content reviewer from gaining ownership of the information (e.g., copy, save, and print functions are disabled) and prevents a loss of content custody for the content owner.

As shown in the architectural design generally illustrated in FIG. 1 (0100), the CCP (0110) is the central conduit that works in a one-to-many relationship with the Content Collaboration Agent (CCA) servers (0120, 0130). It performs a bi-directional synch with all of the CC Agent Servers connecting to it and contains the master database for organizations, users, workspaces, access rights and country restrictions rules. The CCP will also contain business logic to transmit requests from the CCP to the originating CC Agent Servers, retrieve the results and display the results within the workspaces.

Authorized connections are enabled by license key at the CC Agent Server connecting one entity (e.g., a corporation) to one or more entities (e.g., law firms) once connection fees have been purchased. The connection must be secure and not allow access to any unauthorized CC Agent Server(s).

### Method Overview (0900)

The present invention system may be utilized in the context of an overall document management method wherein the document management system described previously is used to execute the following steps:
(1) defining a workspace (0901);
(2) defining the Content Reviewer (CREV) identification and characteristics (0902);
(3) associating CREV access to Data Content and/or Documents (DCDS) through the workspace (0903);
(4) inviting the CREV to collaborate on the DCDS (0904);
(5) generating the copy for the modification by the CREV (0905); and
(6) synchronizing modifications to said copy in said DCDS (0906).

One skilled in the art will recognize that these steps may be rearranged and/or augmented without departing from the spirit of the invention.

### BRIEF DESCRIPTION OF THE DRAWINGS

For a fuller understanding of the advantages provided by the invention, reference should be made to the following detailed description together with the accompanying drawings wherein:

FIG. 1 illustrates a preferred exemplary system application context for the present invention;

FIG. 2 illustrates an exemplary client system implementing certain embodiments of the present invention;

FIG. 3 illustrates an exemplary diagram of a system environment for implementing certain embodiments of the present invention;

FIG. 4 illustrates an exemplary system hardware context in which the present invention may operate, illustrating the positioning of the CCP outside of the firewalls protecting various client application servers;

FIG. 5 illustrates exemplary CCP functions and workspace tabs (functions) that may be implemented in various preferred invention embodiments;

FIG. 6 illustrates a diagram depicting exemplary client application functionality and agent server functionality;

FIG. 7 illustrates a diagram depicting exemplary CCP data bridging functionality between multiple content owners and content reviewers;

FIG. 8 illustrates an exemplary system block diagram illustrating the relationship between remote reviewers and content owner communication through the CCP;

FIG. 9 illustrates a flowchart depicting an exemplary invention overview method embodiment;

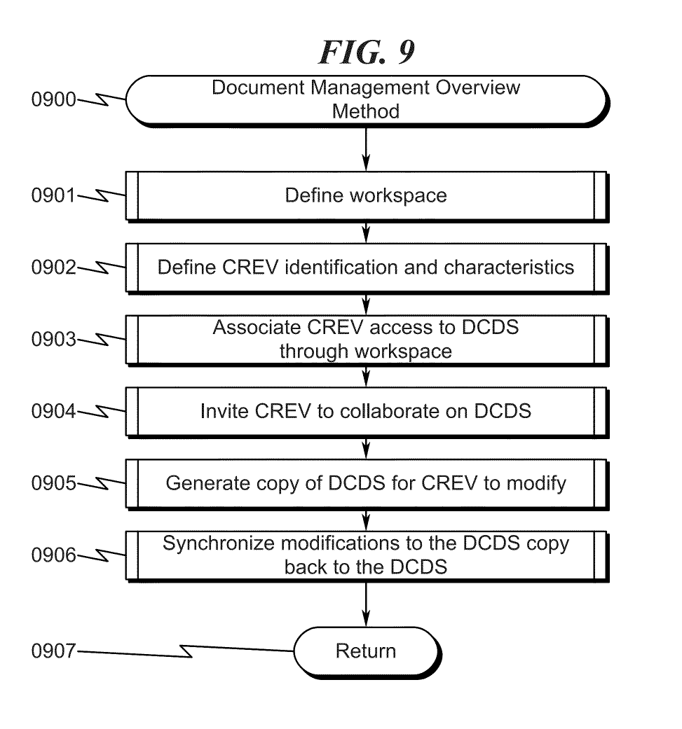

FIG. 10 illustrates a flowchart depicting an exemplary invention detail method embodiment;

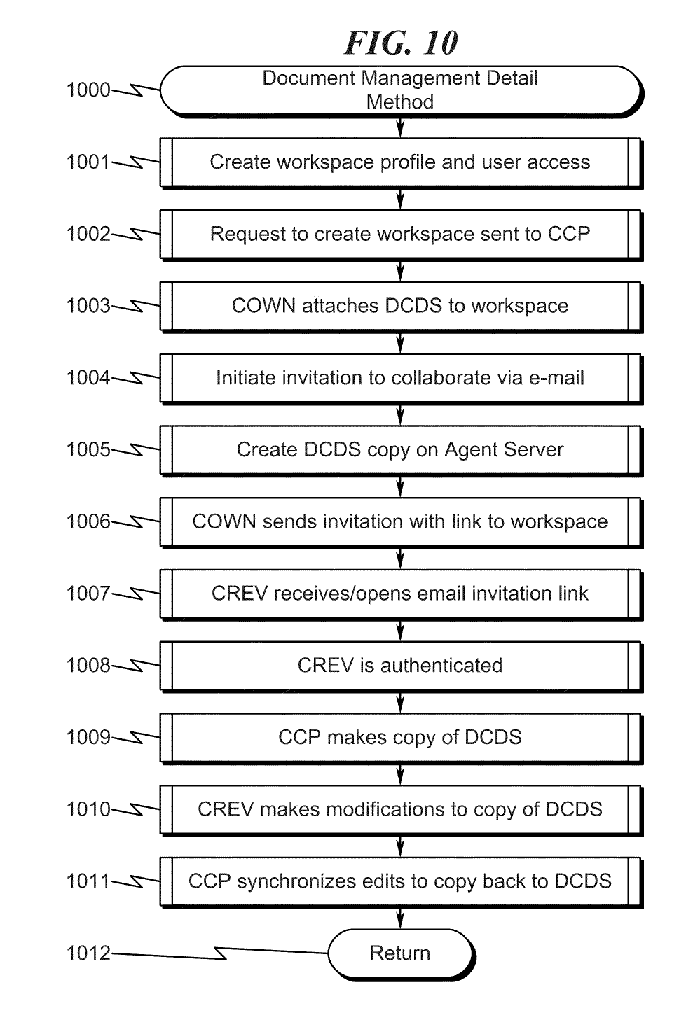

FIG. 11 illustrates a flowchart depicting an exemplary invention detail method embodiment implementing a content owner collaboration continuation method;

FIG. 12 illustrates a flowchart depicting an exemplary invention detail method embodiment implementing a Content Owner Calendar Due Date/Alert Initiation method;

FIG. 13 illustrates a flowchart illustrating an exemplary workspace creation method consistent with certain disclosed embodiments of the present invention;

FIG. 14 illustrates a flowchart illustrating an exemplary workspace update method consistent with certain disclosed embodiments of the present invention;

FIG. 15 illustrates a flowchart depicting an exemplary collaboration review method consistent with certain disclosed embodiments of the present invention;

FIG. 16 illustrates a flowchart depicting an exemplary synchronization method consistent with certain disclosed embodiments of the present invention;

FIG. 17 illustrates an overview flowchart of an exemplary workflow method useful in implementing some preferred CCP invention embodiments

FIG. 18 illustrates a flowchart of an exemplary content owner collaboration start method useful in implementing some preferred CCP invention embodiments;

FIG. 19 illustrates a flowchart of an exemplary content reviewer start collaboration method useful in implementing some preferred CCP invention embodiments;

FIG. 20 illustrates a flowchart of an exemplary secondary content owner update method useful in implementing some preferred CCP invention embodiments;

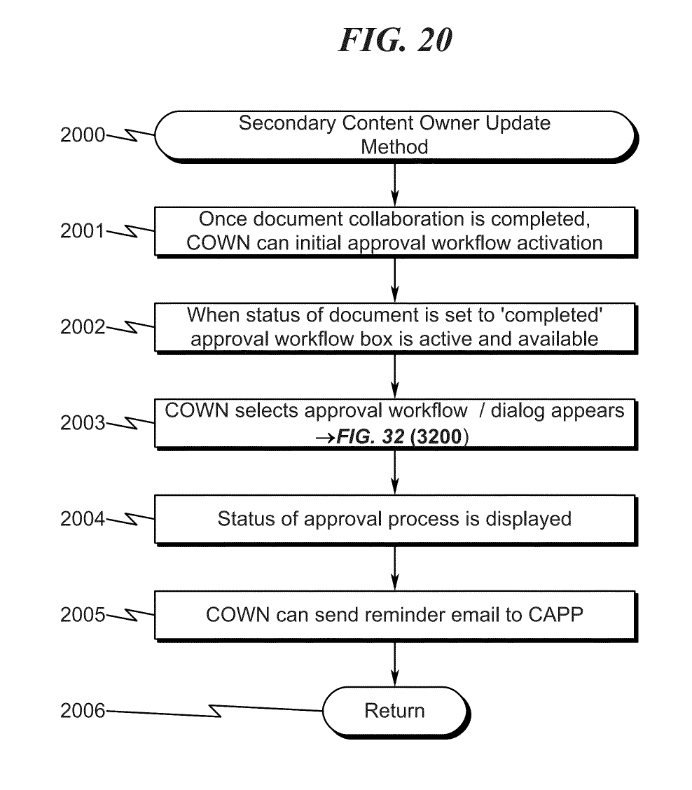

FIG. 21 illustrates a flowchart of an exemplary content reviewer continued collaboration method useful in implementing some preferred CCP invention embodiments;

FIG. 22 illustrates a flowchart of an exemplary approval initiation method useful in implementing some preferred CCP invention embodiments;

FIG. 23 illustrates a flowchart of an exemplary approval invitation method useful in implementing some preferred CCP invention embodiments;

FIG. 24 illustrates a flowchart of an exemplary approval completion method useful in implementing some preferred CCP invention embodiments;

FIG. 25 illustrates an exemplary CCP workspace dialog screen (1/2) useful in some preferred invention embodiments;

FIG. 26 illustrates an exemplary CCP workspace dialog screen (2/2) useful in some preferred invention embodiments;

FIG. 27 illustrates an exemplary CCP workspace creation dialog data definition useful in some preferred invention embodiments;

FIG. 28 illustrates an exemplary CCP user authorization dialog data definition useful in some preferred invention embodiments;

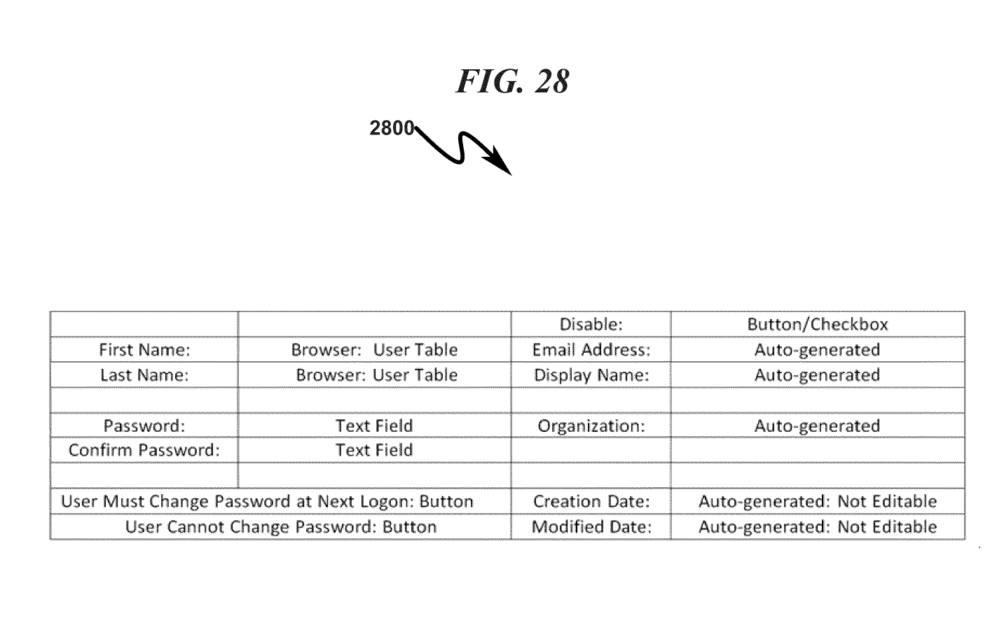

FIG. 29 illustrates an exemplary CCP access control dialog data definition useful in some preferred invention embodiments;

FIG. 30 illustrates an exemplary CCP documentation identification dialog data definition useful in some preferred invention embodiments;

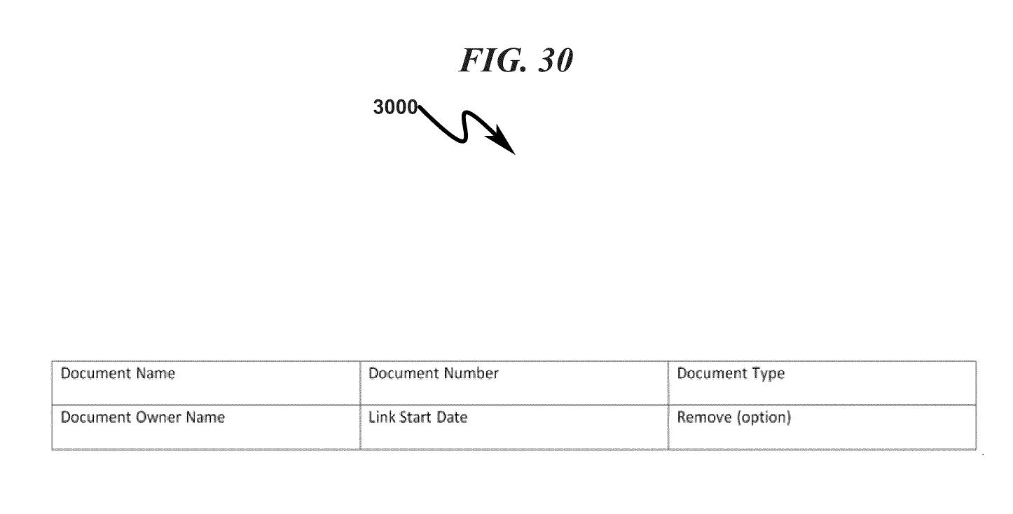

FIG. 31 illustrates an exemplary CCP workspace attribute dialog data definition useful in some preferred invention embodiments;

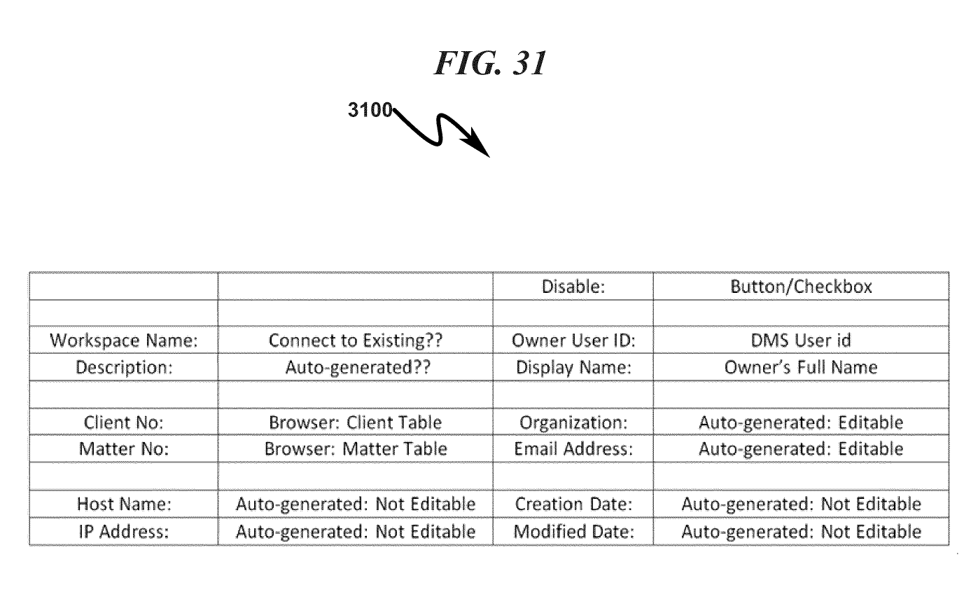

FIG. 32 illustrates an exemplary CCP approval flow dialog data definition useful in some preferred invention embodiments.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a DOCUMENT MANAGEMENT SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Document Management Not Limitive

The present invention will use the term “document management” and its derivatives to broadly cover the management and synchronization of content, project, and matter data. Within this context the term “document” should be broadly construed to include any type of data that can be used in a collaborative manner, including but not limited to traditional word processing documents, photograph files, audio/music files, video files, music files, and combinations thereof. While the present invention may implement this document management using a bidirectional synchronization mechanism, the present invention is not necessarily limited to the use of bidirectional synchronization in this context.

### Method Steps Not Limitive

The general method steps described herein may be modified heavily depending on a number of factors, with rearrangement and/or addition/deletion of steps anticipated by the scope of the present invention. Integration of the described methods and other preferred exemplary embodiment methods in conjunction with a variety of preferred exemplary embodiment systems described herein is anticipated by the overall scope of the present invention.

### Computing Device Not Limitive

The present invention may utilize the term “computer system”, “computing device (CD)” or its equivalent in describing various control systems used within the present invention. These synonymous terms should be given their widest possible interpretation in this context, and are specifically anticipated to include mobile/portable computing devices such as handheld computers, tablet computers, smartphones, cell phones, laptop computer, and the like.

### Embodiments are Exemplary

It is to be understood that both the foregoing general description and the following detailed description are exemplary and explanatory only and are not restrictive of the disclosed and/or claimed embodiments. Further features and/or variations may be provided in addition to those set forth herein. For example, the disclosed embodiments may be directed to various combinations and subcombinations of the disclosed features and/or combinations and subcombinations of several further features disclosed below in the detailed description.

### Preferred System Embodiment (0100)

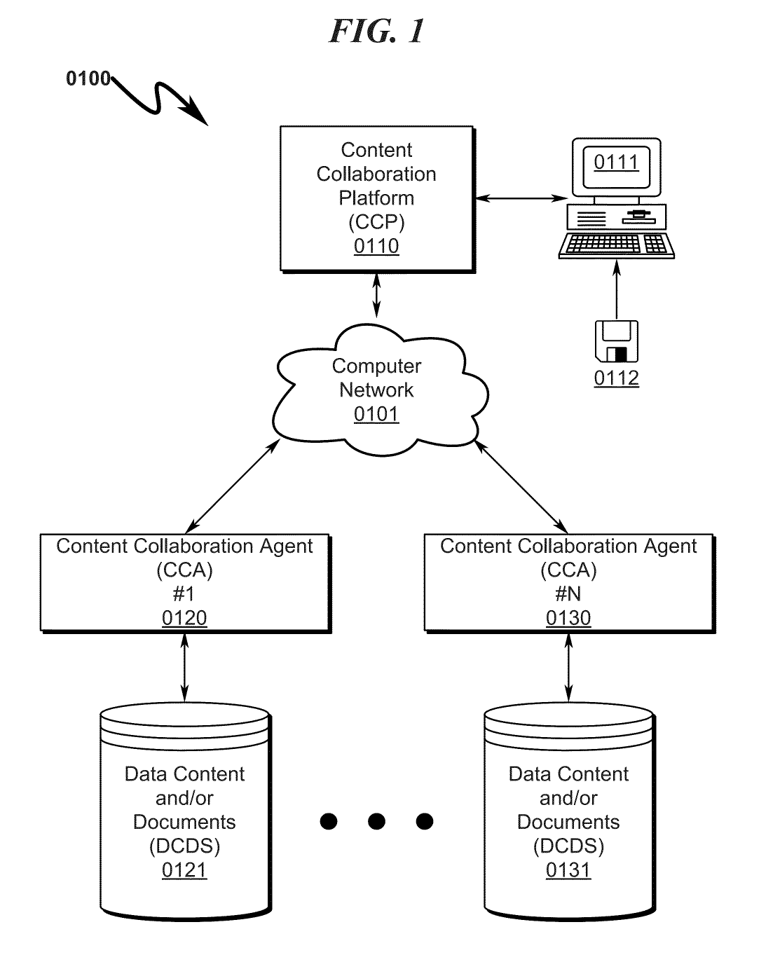

A preferred exemplary invention system embodiment is generally illustrated in the block diagram of FIG. 1 (0100) and will now be described in overview. FIG. 1 illustrates an exemplary system environment (0100) consistent with certain disclosed embodiments. In one example, system (0100) provides a collaboration environment where client systems (0120, 0130) are interconnected connected over a computer network (0101) and can share and edit information via a CCP (0110). In certain embodiments, system (0100) enables a user to share information by, for example, synchronizing documents created by one or more clients (0120, 0130) with the CCP (0110) and providing access to those documents via the CCP (0110) through links to the CCP (0110) in accordance with certain embodiments of the present invention.

Client (0120, 0130) may be a computer system including one or more computing components for performing one or more processes consistent with certain aspects of the disclosed embodiments. In one embodiment, client (0120, 0130) may include one or more computer or data processing devices that have hardware (e.g., one or more processors, storage memory, data buses, network interface, etc.), software (e.g., web browsers, application programs, operating systems, other executable program code written in any known programming language such as PL/SQL, AJAX, XML, JavaScript™, C, C++, Java™, etc.), and/or firmware (e.g., software embedded in a hardware device). Client (0120, 0130) may be configured to communicate with one or more communication networks, such as the computer network (0101), and with other clients or servers connected to the computer network (0101) or other computers or components connected to a local network (not shown). One or more users may operate one or more components of client (0120, 0130) to perform one or more processes consistent with the disclosed embodiments. Moreover, client (0120, 0130) may execute software processes stored on tangible and non-transitory computer-readable mediums that perform one or more processes consistent with the disclosed embodiments. While FIG. 1 (0100) illustrates two clients (0120, 0130), aspects of the disclosed embodiments are not limited to such a configuration. Thus, the disclosed embodiments may be implemented with any number of clients interconnected by the computer network (0101). Further, the term “client” used herein to describe client (0120, 0130) is not intended to be limiting to a client in the sense of known client-server configurations, although such configurations may be implemented by the disclosed embodiments. For example, client (0120, 0130), may be (or include) a server type computer system that may also request and receive information, data, services, processes, etc. from another computer system in a local and/or remote network.

In one embodiment, client (0120, 0130) may create, maintain, edit, modify, copy, send, receive, store, delete, and the like one or more documents. In one non-limiting example, a document may be a file, content, or information that software, processors, and/or users may use. For example, a document may be a word processing document containing content (e.g., text, graphics, links, etc.). A document may also be a spreadsheet file, a web page, a PDF file, or any other type of file that includes content that may be viewed, edited, modified, copied, shared, etc. by a user, processor, or software. A document may be included in a folder containing multiple documents. For example, disclosed embodiments may work with one or more folders containing many documents, such as multiple word processing files, spreadsheets, tables, graphical files, etc. A folder may also include one or more subfolders, each containing one or more documents. The above-listed examples of documents are not intended to be limiting to the disclosed embodiments.

In one embodiment, client (0120, 0130) and their respective user(s) may be an owner or a reviewer. For example, an owner may be a user or client that creates, maintains, controls, or otherwise is an owner of a document or a folder that contains multiple documents. An owner may share one or more documents through the CCP (0110) in accordance with certain disclosed embodiments. An owner may also edit, modify, delete, and copy a document that is owned by the owner. For example, an owner may create a word processing document and have access rights to view, modify, and otherwise alter the contents of that document in accordance with the disclosed embodiments. Another user may also have access to that document and thus may also be an owner. A client, such as client (0120), may be used by one or more users to create, modify, copy, delete, and/or share one or more documents, and thus may also be an owner. A reviewer may be a user or client that accesses, reviews, analyzes, modifies, comments on, edits, or otherwise works with a document shared by an owner in accordance with certain disclosed embodiments.

In certain embodiments, an owner of a document may be a reviewer of another document, and the reviewer of a document may be the owner of another document. For example, client (0120) may be an owner of a word processing document created by a user associated with client (0120) and shares that document with client (0130) through the CCP (0110). In this example, client (0130) may be a reviewer of the word processing document shared by client (0120). Client (0130) may also be an owner of a spreadsheet document that is shared with client (0120) through the CCP (0110). In this example, client (0120) is an owner of the word processing document and a reviewer of the spreadsheet document, while client (0130) is an owner of the spreadsheet document and a reviewer of the word processing document.

In certain embodiments, any number of clients (and users) may share documents using the CCP (0110). Thus, owners and reviewers may be individuals or groups of individuals with access to the CCP (0110) using client (0120, 0130). A document may have one or more owners, and may be accessible by one or more reviewers depending on various owner-determined user authorizations and access rights. Certain embodiments enable the CCP (0110) to establish access rights that will not allow one or more reviewers to retain copies of an owner's document, enabling the owner to retain complete control over their document. In other embodiments, owners may grant varying levels of access rights to reviewers, such that certain reviewers may alter or gain control over certain shared documents or underlying information, files, content etc. in a document.

Referring back to FIG. 1 (0100), the computer network (0101) may be any type of communication network configured to communicate information in system (0100). The computer network (0101) may be a wireless and/or wireline network including one or more components (e.g., hardware, software, and/or firmware) configured to receive, route, translate, and deliver information. For example, the computer network (0101) may be the Internet, an Extranet, an Intranet, a Local Area Network, etc. that enables clients (or other computer systems) to communicate and collaborate in accordance with aspects of the disclosed embodiments. The computer network (0101) may include infrastructure that implements the communication and collaboration of information over these types of networks, such as routers, bridges, servers, wireless/wireline base stations, transceivers, and related technology.

The CCP (0110) may be a system that provides collaboration and other types of information sharing processes consistent with the disclosed embodiments. In one example, the CCP (0110) may be a web-based computing system that interconnects with one or more clients, such as clients (0120, 0130), over the Internet. In one example, the CCP (0110) may include one or more servers and memory storage devices. For instance, the CCP (0110) may include one or more computer or data processing devices that have hardware (e.g., one or more processors, storage memory, data buses, network interface, etc.), software (e.g., web browsers, application programs, operating systems, other executable program code written in any known programming language such as PL/SQL, AJAX, XML, JavaScript™, etc.), and/or firmware (e.g., software embedded in a hardware device). The CCP (0110) may also include one or more memory devices, such as local or networked memory storage media, shared memory platforms, or a combination thereof. In certain embodiments, the CCP (0110) includes memory that stores documents, folders of documents, information, content, data, etc. for transmission and viewing by clients (0120, 0130) through browser or similar type of software. In accordance with disclosed embodiments, the CCP (0110) temporarily provides access to such information in virtual memory during communication sessions with a client (e.g., client (0120, 0130)), and deletes the information from its virtual memory at the end of a communication session with the client.

The CCP (0110) may be configured to execute software that performs processes consistent with the disclosed embodiments. For example, the CCP (0110) may perform security processes that control access to documents, folders of documents, or any other information that may be temporarily stored and processed by CCP during a communication session with one or more clients (0120, 0130). The CCP (0110) may also perform collaboration processes that enable clients (0120, 0130) (or their users) to share and collaborate on documents, folders of documents, content, or other information over the computer network (0101). The CCP (0110) may also perform processes that enable users or clients to communicate via, for example, email or instant messaging. In certain disclosed embodiments, the CCP (0110) may also provide application specific operations, such as content viewer, editor, collaboration, approval, compare, clean, PDF-creating, reporting, and/or administrative applications, calendar, and security, functions. The CCP (0110) may also execute software that allows multiple clients or their users to simultaneously log-in and interact through hosted communication applications, such as instant messaging or other real-time communications functions. The CCP (0110) may also provide message boards, private messaging, wall postings, email, and various other methods of electronic communication known in the art.

In certain embodiments, the CCP (0110) performs processes that may display content links to shared content, including data, documents, folders, and other information through a workspace. A workspace is a virtual environment hosted by the CCP (0110) that facilitates collaboration and sharing among owners and reviewers. A workspace may be customized by users of clients (0120, 0130) to display customized information over the computer network (0101) during communication sessions between the CCP (0110) and clients (0120, 0130). Workspaces may be created by a client (e.g., client (0120, 0130)) via user input. In one embodiment, a user who creates a workspace may configure user authorizations and access rights to permit owners to share documents, folders, content, etc. and to permit reviewers to access and possibly edit that information on the workspace. The CCP (0110) may be configured to include content links within a workspace that, when selected by a client owner or reviewer (0120, 0130), retrieve documents, folders of documents, content, etc. from a client owner for rendering the requested information. A workspace may further enable owners to configure user authorizations and access rights for each content link, enabling owners to exercise control over their documents, folders, or content. In accordance with certain disclosed embodiments, owners may publish links to content on the workspace through, for example, a content sharing method described below.

In certain embodiments, a workspace may be configured to include areas that are designated for certain features and for owners or reviewers. In one example, a workspace may include display tabs for providing email, calendar, news, history, reporting, activity log, instant messaging, message boards, links to other workspaces, and tabs for rendering information relating to specific tasks, matters, projects, or features. In further embodiments, a workspace may also display custom tabs created and configured by a user (or client) that created the workspace, or by other authorized users (or clients) with access rights to configure custom tabs.

Owners may create their own workspaces and reviewers may, if authorized, add documents, content, etc. to be included in an owner's workspace. Workspace views may be customized and dictated by user access rights, such that documents, folders, content, browser menu options will or will not be available in accordance with user access rights, such as blocking save as or print options if specific rights have not been granted. In one embodiment, for example, a user may initiate a request at client (0120) to create a new workspace. Client (0120) may perform processes that enable the user to configure owner/reviewer rights to the workspace, select documents, folders, content etc. that are to be included in the workspace, and set authorizations and access rights for some or all of the documents, folders, and content associated with the workspace. The user may therefore authorize only certain users—owners and reviewers—to access the new workspace, and may grant different levels of access to the documents, folders, and content included in the workspace among the authorized users. For example, a user may authorize certain reviewers to have access to review—but not edit—selected documents, while permitting other reviewers to both review and edit that same documents. In a further embodiment, an owner may permit certain reviewers only temporary access to review and/or edit shared content provided by the CCP (0110), but permit other reviewers to retain and save copies of the shared content. Through various disclosed embodiments, owners may grant reviewer authorizations and varying levels of access in order to, for example, retain control over their shared content, or to permit certain reviewers to alter that content, or to permit certain reviewers to retain and save copies of that content. In another embodiment, the CCP (0110) may be configured to perform access control rules that adhere to Country data privacy restrictions that prevent access to any information outside of restricted Countries.

### Exemplary CCA Components (0200)

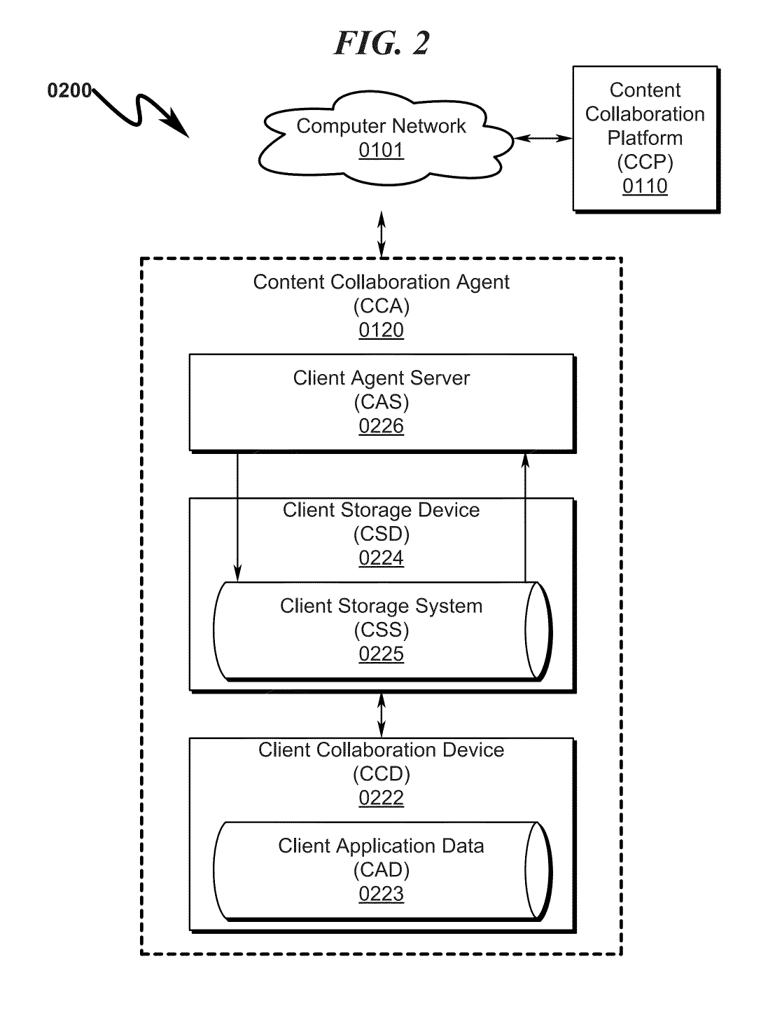

FIG. 2 (0200) illustrates components of an exemplary client (0120) consistent with the disclosed embodiments. The illustration, descriptions, functionalities, and operations disclosed in connection with client (0120) are also applicable to client (0130) (or other clients that may be implemented in system (0100)). As shown, client (0120) may include one or more client devices (0222), one or more client storages (0224), and one or more agent servers (0226).

Client device (0222) may be one or more computer systems configured to execute software, create, edit, modify, manage, etc. documents, and send and receive documents. For example, client device (0222) may be a desktop PC, a laptop, a PDA, a workstation, tablet, cell phone device, smart phone device, or any other processor, computer, or device (or group thereof) configured to locally or remotely execute software, send and receive information over a network, such as the internet, and perform data processing operations. In one embodiment, client device (0222) may include one or more computer or data processing devices that have hardware (e.g., one or more processors, storage memory, data buses, network interface, etc.), software (e.g., web browsers, application programs, operating systems, other executable program code written in any known programming language such as PL/SQL, AJAX, XML, JavaScript™, etc.), and/or firmware (e.g., software embedded in a hardware device).

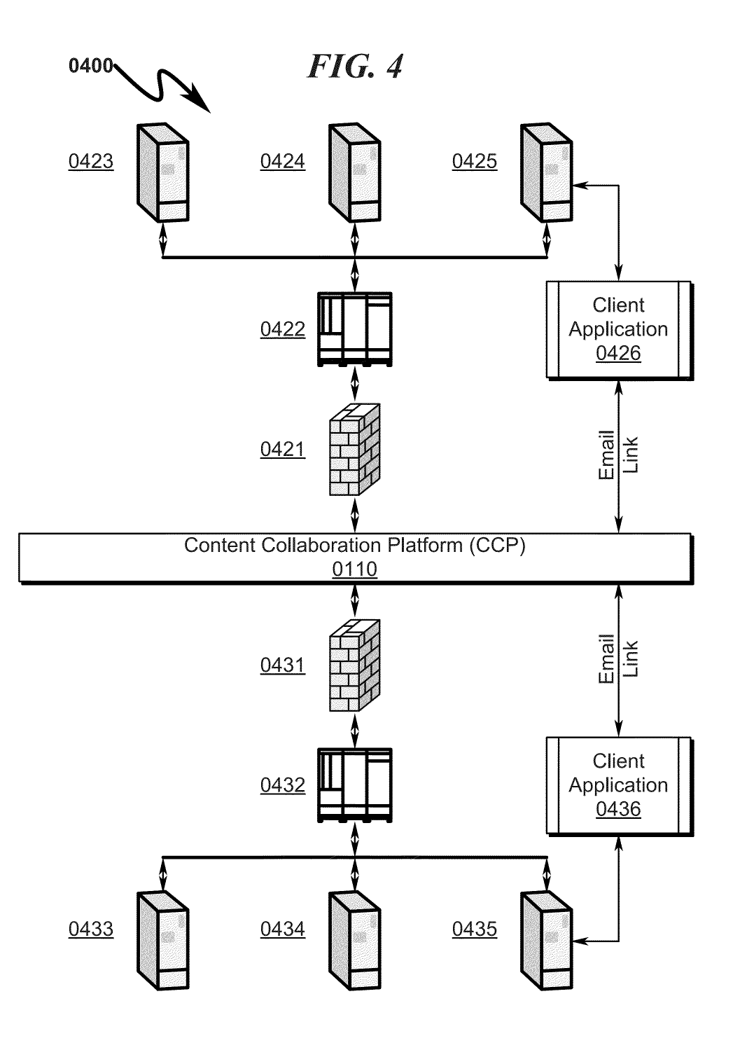

One or more users may operate client device (0222) to perform functions consistent with certain embodiments of the disclosed invention. In certain embodiments, client (0222) may execute software that performs processes that access one or more client storage (0224) and agent server (0226), and may also access the CCP (0110) through a secured layer, such as a firewall (0421, 0431) (as generally depicted in the structure FIG. 4 (0400)). In one embodiment, client device may include one or more client applications (0223), which may be software applications that work with documents, data, content or other types of information. For example, client application (0223) may include a work processing application, such as MICROSOFT WORD®, a spreadsheet application, a database or database management system (DMS) client application, an email application (e.g., MICROSOFT OUTLOOK®), and/or a document review and collaboration application, such as a Workshare Professional client. Client device (0222) may include one or more client applications (0223) that provide different types of features, such as email, document creation and editing, document comparison, PDF processes, web-page related applications, graphical drawing applications, financial service applications, etc., without departing from the features of the disclosed embodiments. In one embodiment, through client application (0223), client (0222) may host and provide one or more of the following services and capabilities: access rights selection, content viewer, content editor, collaboration, content approval process, content compare and/or redline, calendar, email, reporting, and administration.

In one embodiment, client application (0223) may include the functionality to create workspaces and invite reviewers to access documents or folders in a workspace. For example, aspects of the disclosed embodiments enable a word processing application to include a “create workspace” tab that a user may select to create a workspace rendered by the CCP (0110) during a collaboration session. The word processing application may also include ribbons or hot-key combination logic that enables a user to initiate an invite to one or more reviewers to access and review a document created or changed using the word processing application.

Client storage (0224) may be one or more local or network memory storage media, or internal and/or external network-based document or data management systems. For example, client storage (0224) may include one or more storage systems (0225) that include one or more computer systems (e.g., database servers) and one or more tangible non-transitory storage media, such as one or more databases, hard drives or other types of storage devices. Storage system (0225) may include, for example, a document or database management system (DMS), such as SharePoint®, Desksite®, Autonomy, OpenText Tempo™, WorldDox®, NetDocuments®, or network storage. In certain embodiments, storage system (0225) may store original documents created by an owner user using client application (0223) executed by client device (0222). Storage system (0225) may also store versions of original documents that may include changes made by the owner or one or more reviewers through the CCP (0110). In certain embodiments, client storage (0224) may provide access to documents and folders of documents through client device (0222) and/or agent server (0226) to select data, documents, folders of data or documents, or other content to share over the CCP (0110).

### CCA Storage

In certain embodiments, client storage (0224) may store original documents created by owners and corresponding collaboration files that are document versions for any changes to an original document. In one embodiment, the collaboration files are stored in a format that is different from the format of the original document. For example, an original document may be created as a MICROSOFT WORD° document (e.g., .docx file format), but the collaboration file for that original document may be stored as a content collaboration file (e.g., .ccf file format) based on changes made using document editing tools during a collaboration session. Client storage (0224) may execute a stub-holder that pulls in an original document from storage and compares all collaborative changes captured during a collaboration session. Client storage (0224) may also store an edit history table and a version control table that maintain historical information reflecting edits made to a particular document and the versions of the document created based on those documents.

### CCA Server

Agent server (0226) may include one or more computers configured to execute software that performs one or more processes consistent with the disclosed embodiments. Agent server (0226) may be configured to perform synchronization functions with the CCP (0110) and client storage (0224) to maintain up to date versions of original documents, folders, and other content provided in workspaces. In certain embodiments, agent server (0226) may be configured to function as an interface to access the CCP (0110). Thus, in certain embodiments, software, algorithms, web rendering logic, data, etc. used to provide applications may reside in the CCP (0110), and not with agent server (0226). Agent server (0226) may be configured to receive requests related to applications, for example, from client device (0222). Agent server (0226) may also be configured to deliver requests to the CCP (0110), and to receive application or application-related information from the CCP (0110).

Although FIG. 2 shows client device (0222), client storage (0224), and agent server (0226) as separate components, the disclosed embodiments may implement single computer systems that operate as a client device (0222), client storage (0224), and agent server (0226), or any combination thereof.

In one embodiment, agent server (0226) may include one or more computer or data processing devices that have hardware (e.g., one or more processors, storage memory, data buses, network interface, etc.), software (e.g., web browsers, application programs, operating systems, other executable program code written in any known programming language such as PL/SQL, AJAX, XML, JavaScript™, etc.), and/or firmware (e.g., software embedded in a hardware device) that provide information to, and receive information from the CCP (0110). Agent server (0226) may include one or more databases that maintain information and tables for managing and performing collaboration functions consistent with the disclosed embodiments. For example, agent server (0226) may include an edit history table that maintains date and timestamp information relating to a transaction associated with the creation or update of an original document stored in client storage (0224). The edit history table in the agent server may also include an identifier (e.g., UserId) of the client or user that initiated the transaction (e.g., create or edit). Agent server (0226) may also store in entries in its edit history table to log an invitation generated by agent server (0226) to notify one or more reviewers of a transaction (e.g., document creation or edit). The invitation log data may include a date and timestamp of the transaction, and the identifier of the user or client that initiated the transaction. Agent server (0226) may also create and maintain an invitation table that stores an activity record of the email address (or similar contact information, such as IP address, etc.) for each recipient of the invitation that may be associated with the invitation (e.g., email) record maintained in the edit history table.

### CCA Server Functions

Agent server (0226) may maintain copies of documents and all collaborative changes as separate data objects for document management and version control. The edit history and version controls are bi-directionally synchronized with the original document maintained by client storage (0224). In certain embodiments, agent server (0226) executes software that provides the functional logic to control:
database operations, including creation of user accounts, unique identifiers, global unique identifiers for workspaces, activity logs and connection history;
content flow and distribution;
connection access and communication with the CCP (0110), client storage (0224), client device (0222), and other systems (e.g., client (0130));
integrated security technologies to secure connections and content within the CCP (0110);
distribution and execution of application services and backend technologies (e.g., document processing, change management, spreadsheet, metadata management, etc.); and
integration with native controller(s) to create and maintain user accounts.

Agent server (0226) may also execute software that collects and maintains internal and external UserIds, including those based on email addresses, and also retrieves IP information when a user (e.g., an owner or reviewer) logs on to the CCP (0110) to determine geographic location of the user. In one embodiment, agent server (0226) may perform processes that use the retrieved IP address to control and adhere to Country specific data privacy restrictions, such that, for example, workspace views outside of a restricted Country will not be allowed. For example, agent server (0226) may prevent a reviewer from the United States to view workspace documents that originated from an owner from Sweden based on governing laws that may prevent foreign users from viewing certain information. In one aspect, agent server (0226) may maintain and execute one or more rules that analyzes Country identification information extracted from a user's IP address when they log on to the CCP (0110) to determine whether to apply access restrictions to a workspace, or documents or content within the workspace. Other types of geographical based access restrictions may also be implemented, such as restrictions based on GPS locations, State, zip code, domain names, etc.

### Document Administrations/Configuration

Agent server (0226) may also execute software the performs workspace and document administration/configuration functions, such as controlling user or client access, available views, and services based on permissions granted at time a user account was created. For example, agent server (0226) may perform processes that ensure that the identifier (e.g., UID) for each external UserId is configured such that there is only one account created for each user and also allows for association to one or more other workspaces.

### CCA Processes

Agent server (0226) may also execute software that performs processes that provide, for example:
Viewer Services, which provides the ability for a reviewer or owner to view content either locally or online;
Editor Services, which provides the ability for an owner or reviewer to edit documents or content either locally or online;
Compare Services, which may send a request to a server or other computer running document comparison applications to provide the ability to compare versions of content against another version and return the results of the request;
Information Rights Management Service, which may send a request to a server or other computer running software to provide the ability to clean content of all default metadata (as described above), stamp/encrypt into the document the originating source information (e.g., Author and Company Names, date and time, etc.) and information relating to a user that the document will be sent to into the property of the document so that the added information cannot be removed by any metadata cleaning solution and return the clean and stamped file to Agent Server (0226) for final delivery;
PDF/Digital Signature Service, which may send a request to a server or other computer running software to provide the ability to convert a document to PDF format and insert a digital signature into the document.

In one aspect, if the document is altered in any manner, the software removes the digital signature and invalidates the document and returns the signed document to Agent Sever (0226) for final delivery.

Clients (e.g., (0120, 0130)) that interconnect with the CCP (0110) in system environment (0100) may employ a system of components similar to the system disclosed in FIG. 2 (0200). In one embodiment, an owner (e.g., client (0120)) and a reviewer (e.g., client (0130)), or multiples thereof, may each utilize the components of client device (0222), client storage (0224), and agent server (0226), all interconnected by the same CCP (0110). In accordance with certain embodiments, each user may share documents and content as owners by publishing links on a workspace to the CCP (0110) through agent server (0226) or client device (0222). Users may then also review and/or edit documents as reviewers by opening the links on a workspace to the shared documents rendered by the CCP (0110).

In certain embodiments of the invention, however, reviewers may not need to employ one or more of a client device (0222), client storage (0224), or agent server (0226). For example, the disclosed embodiments may be configured such that a reviewer that provides edits and/or comments on an owner's document may access links to the document without the use of agent server (0226). As one example, the disclosed embodiments provide for configurations where an owner may grant certain reviewers the option to review linked content via email within, as one example, a browser window. Thus, certain embodiments of the disclosed invention may enable reviewers that do not use an agent server (0226) to participate in collaborating with owners.

### Exemplary CCA Components/Data Flow (0300)

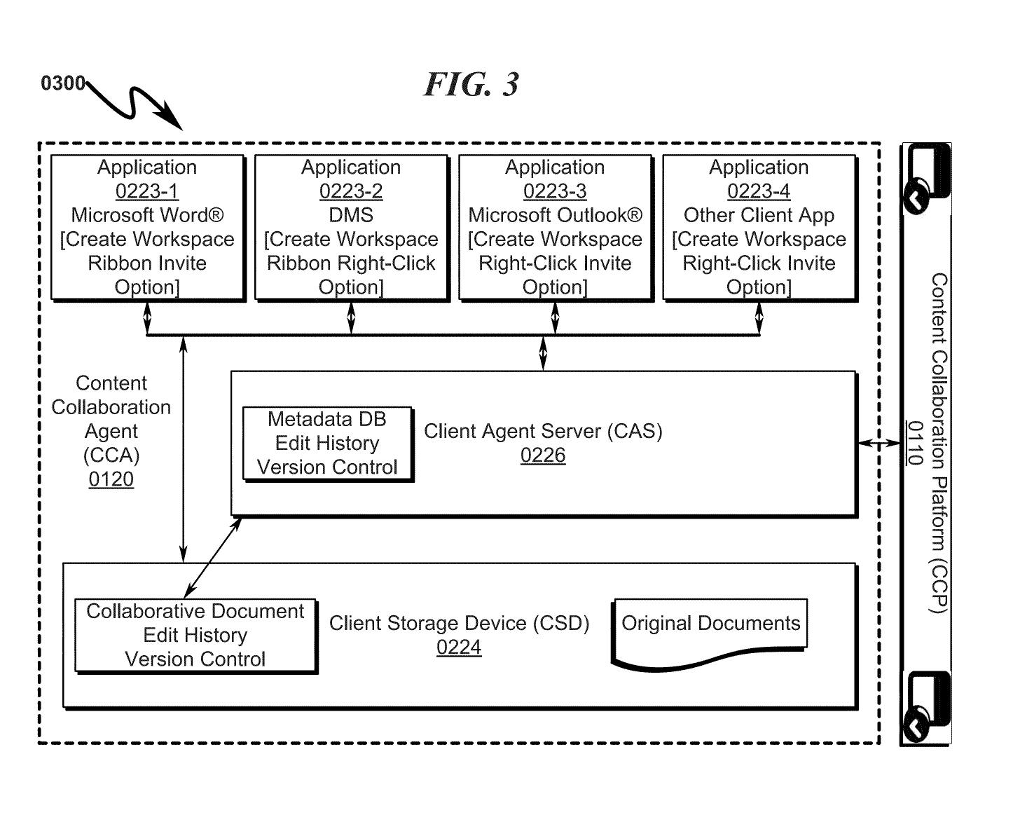

FIG. 3 (0300) provides an overview of how an exemplary CCA (0120) is configured to communicate with the CCP (0110) and various storage architectures and document processing applications. Within this context the following data flow is generally followed:
A workspace and user access rights are first created, tagged with unique identifiers, and then a single document or project folder which houses multiple documents are attached and synchronized to the workspace on the Content Collaboration Platform.
Two activity entries are created to track to log the copy operation of either the single document or each document contained within the project folder to the Edit History tables in the DMS database and the Agent Server database with the current date and timestamp of the transaction, along with the DMS UserId that initiated the transaction.
An email invitation containing a link to a workspace on the Content Collaboration Platform to gain access to a document or project folder houses multiple documents is created from either the custom ribbon within MICROSOFT WORD®, right-click option from the DMS Client, right-click option from the folder menu in MICROSOFT OUTLOOK®, or the ribbon within the Client and sent out by the Agent Server to one or more content reviewers.
Two activity entries are created to log the email operation of either the single document or each document contained within the project folder to the Edit History tables in the DMS database and the Agent Server database with the current date and timestamp of the transaction, along with the DMS UserId that initiated the transaction. A second activity record of the email address for each recipient is logged within the Agent Server database in the Email Invitation Table and associated with the email record in the Edit History table.
The Reviewer logs onto the Content Collaboration Platform and click on one of the links in the workspace.
The content is opened in Virtual Memory within a Text Editor and the Reviewer begins to review, edit and/or comment on the content.
When the session is completed, the content and changes are removed from the Content Collaboration Platform and saved back to the originating Agent Server.
An activity entry is created to log the save operation to the Edit History Table in the Agent Server database with the current date and timestamp of the transaction, along with the email address of the Reviewer that initiated the transaction. All of the changes are saved to the Agent Server database to the Changes Table and associated with the email address of the Reviewer that initiated the transaction.
The Agent Server communicates with the DMS and creates a new document version entitled Collaboration Document in a proprietary file format, .ccf and sets security access rights to the DMS Userid from the original tractions.
The Agent Server then synchronizes the changes to the Collaboration Document and creates several activity entries to (a) log the create operation to the Versions Table, log the save operation to the Edit History Table with the current date and timestamp of the transaction using the DMS UserId from the original transaction and log the email address of the Reviewer that initiated the transaction.

### Exemplary CCP Email Communication (0400)

FIG. 4 (0400) provides an overview of how the CCP (0110) communicates with agent servers through firewalls using email communication services to coordinate document access via email links. Within this context the following data flow is generally observed:
For the purpose of content review and collaboration, the user selects the ‘Create Workspace’ button on the ribbon of the Client, MS Word, right-click menu from the DMS Client or MICROSOFT OUTLOOK®.
A new workspace profile window is opened and allows the creator to add relevant workspace attributes, create users and set access rights to the workspace.
The request to create a new workspace and user access rights are sent to the Agent Server and then created and assigned a unique identifier within the Content Collaboration Platform.
To begin the collaboration process, the content owner attaches either a single document or a project folder which houses multiple documents to the newly created workspace and initiates a new email invitation from the client, MS Word, DMS client or MICROSOFT OUTLOOK® to one or multiple content reviewers.
The document or project folder containing multiple documents are copied from the original source to the Agent Server and then synchronized to the workspace on the Content Collaboration Platform.
The content owners sends an email invitation which contains a link to the workspace in the Content Collaboration Platform to gain access to the document or project folder is sent from the Agent Server to the intended reviewers.
The email invitation is received and opened by the intended recipient(s)/content reviewer(s) and clicks on the link.
The intended recipient(s)/content reviewer(s) is/are presented with a logon screen for the Content Collaboration Platform and are allowed to create a password to gain access to the workspace.
The content reviewer clicks on one of the document links and the content is opened in Virtual Memory within a Text Editor. When the session is completed, the content and changes are removed from the Content Collaboration Portal and saved back to the originating Agent Server.
The originating Agent Server connects to the original source and synchronizes the changes to a proprietary collaboration file housed within the original source.

### Exemplary CCP Functions/Workspace Tabs (0500)

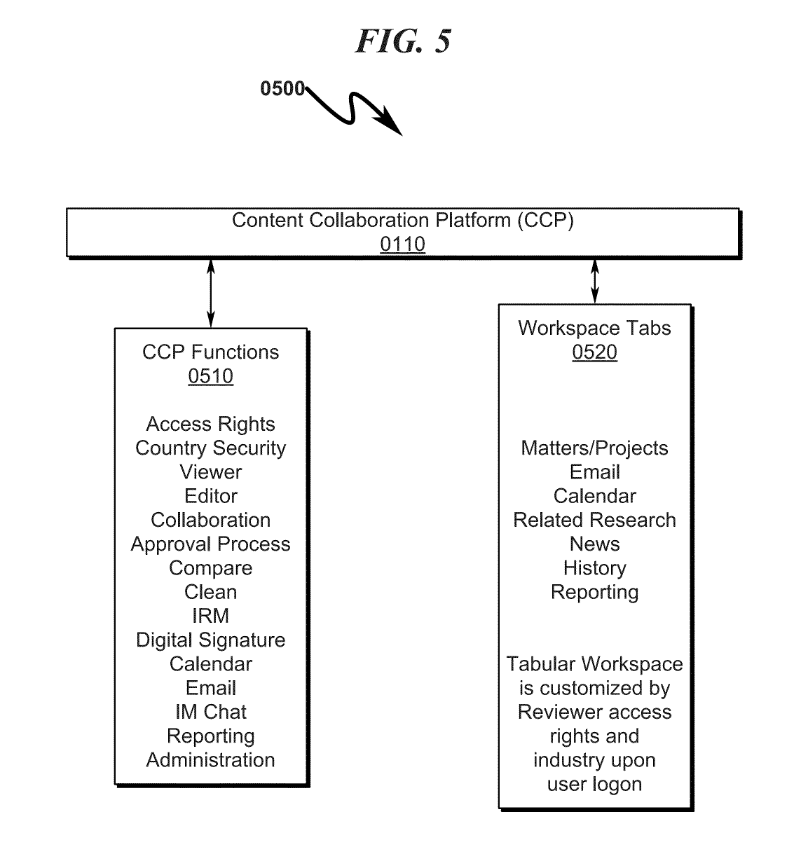

FIG. 5 (0500) provides an overview of CCP functions (0510) and workspace tabs (functions) (0520) that may be included in a number of preferred invention embodiments.

### Exemplary Client Application/Agent Server Functions (0600)

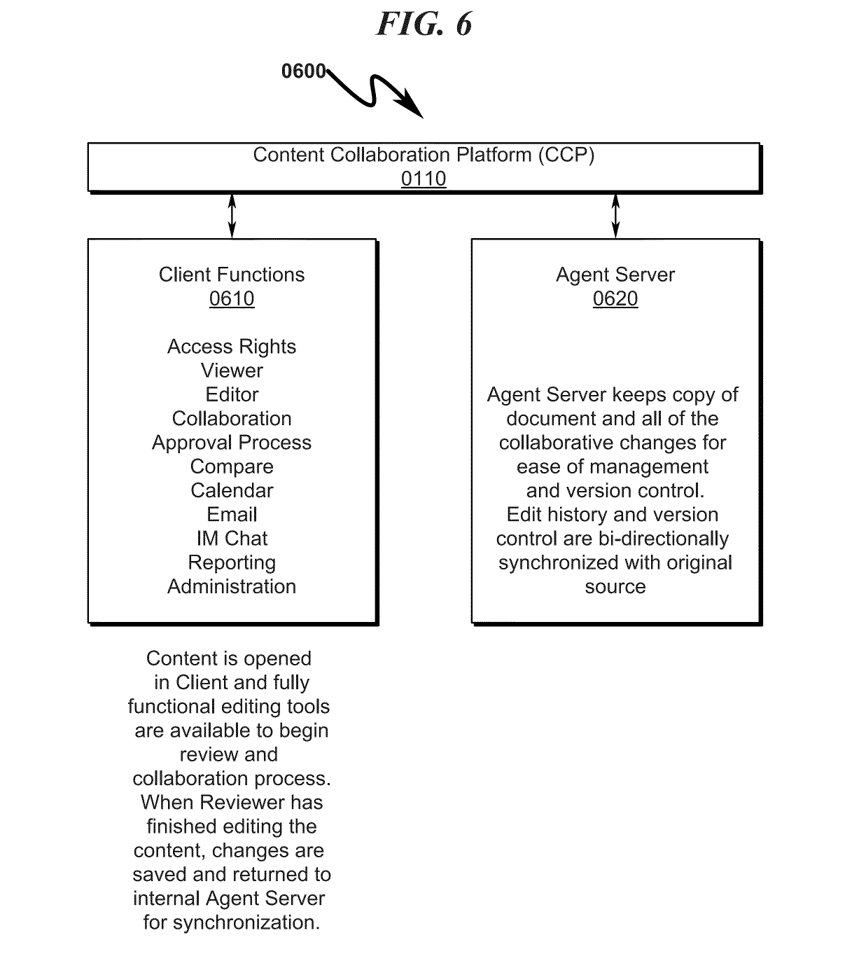

FIG. 6 (0600) provides an overview of client application functions (0610) and agent server functions (0620) that may be included in a number of preferred invention embodiments.

### Client Application Functions

Client applications may include a wide variety of functions, including but not limited to:
A robust text editor.
Connection and access controls are maintained by Agent Server.
Changes to content are saved as database objects within Agent Server and synchronized back original DMS source.
Functionality to create Workspaces and User Account(s) to access Workspaces are available from Ribbon.
Workspace creation and edit dialogues will contain field attributes which are available to be populated such as, Workspace Name, Description, Owner UserId, Display Name, Organization, Email Address, Client/Matter Numbers (or Project Id).
Billing Id (as appropriate to industry), and Disable.
Workspace creation dialog will also contain field attributes that are auto-populated and are not editable, such as, Host Name (or IP Address), Creation Date, Last Modified Date.
User account creation and edit dialogues will contain field attributes which are available to be populated such as, Email Address, First Name, Last Name, Display Name, Password (and confirmation), and Organization. Dialog may also contain security options such as, User must change password at next logon (which will be defaulted on), User cannot change password and Disable.
Access controls dialog will contain functionality options for Content such as View, Edit, Print, Upload (content), and Download (save).
Offline editing will encrypt document content so that it cannot be emailed outside of security protocol.

### Agent Server Functions

Agent servers may include a wide variety of functions, including but not limited to functional logic to control the following features:
Database operations, including creation of user accounts, unique identifiers, global unique identifiers for workspaces, activity logs and connection history; content flow and distribution; connection access and communication with all key systems; integrated hi-tech security technologies to secure connections as well as content within the Platform; distribution and execution of all application client services and backend technologies; integration with native AD controller(s) to create and maintain user accounts internally.
External UserIds should be based on email address and retrieve IP information upon logon to the Platform to determine geographic location.
IP address will be used to control and adhere to Country data privacy restrictions. Views outside of the restricted Country will not be allowed.
User access, available views, and services will be control by permissions granted at time user account was created.
GUID for each workspace will support Country restrictions and consolidate unique matter/project information within content owners' and reviewers' domains.
UID for each external UserId will ensure there is only one account created for each user and also allow for association to another workspace.
Search requests will be completed using the DMS UserId in appropriate repository(ies).

### Agent Server Services

Agent servers may include a wide variety of services, including but not limited to:
Viewer Services. This service will provide the ability to view content either locally or online.
Editor Services. This service will provide the ability to edit content either locally or online.
Compare Services. This service will send a request to the Agent Server to provide the ability to compare versions of content and return the results of the request.
Information Rights Management (IRM) Services. This services will send a request to the Agent Server to provide the ability to clean content of all default metadata, send the cleaned document to the IRM Server to stamp/encrypt into document the originating source information (such as Author and Company Names, date and time) and information of person who document is being sent to into the property of the document so that it cannot be removed by any metadata cleaning solution and return the clean and stamped file to the Agent Server for final delivery.
PDF/Digital Signature Services. This service will send a request to the Agent Server to provide the ability to convert the document to PDF and insert a digital signature into the document. If the document is altered in any way, the file will know to remove the digital signature and invalidate the file and return the signed file to the Agent Sever for final delivery.

### Exemplary CCP Bridge Functionality (0700)

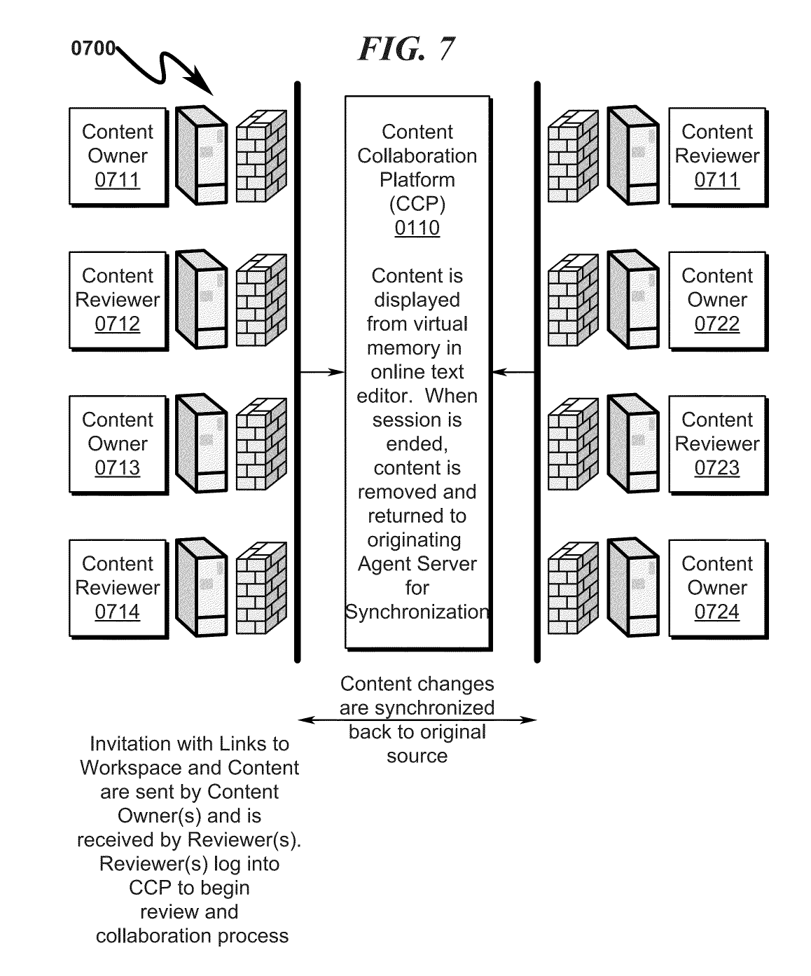

FIG. 7 (0700) provides an overview of how the CCP (0110) serves as a bridge between multiple content owners and content reviewers through the individual firewalls associated with each content owner/reviewer. Within this context the CCP may be configured to provide the following functionality:
Provide a view to content by displaying as a hyperlink and never store a copy of the content.
Content may remain behind firewall of original source of content owner.
Clicking on any hyperlink will initiate call to originating Agent Server for content and display content within Platform or launch online text editor for viewing and/or editing for the purpose of collaboration.
Content and hyperlinks will be loaded into Platform from Virtual Memory and cleared when user session is completed.
Content changes are synchronized back to originating Agent Server and original source.
Views will be customized and are dictated by user access rights. Browser menu options will or will not be available in accordance with user access rights, such as, no save as or print options available if specific rights have not been granted.
Views will adhere to Country data privacy restrictions and will not be available to anyone outside of restricted Country.
Platform Views will contain the following elements: Corporation Matter/Project Folder Listing, Content Tab, Email Tab, Legal Research Tab, News Tab, Team Contact Information, Attorney Profile Information, Matter/Project/Content Calendar, History and Reporting.
Corporation Matter/Project Folder Listing will display Matter Name and default sub-folders (General, Correspondence, Legal Hold).
Content Tab will display listing of hyperlinks to content shared by content owner(s).
Email Tab will display listing of hyperlinks to email threads initiated by content owner(s) and/or reviewer(s).
Legal Research Tab will display hyperlinks to legal research provided by content owner(s).
News Tab will display hyperlinks to news articles provided by content owner(s).
Team Contact Information will display hyperlinks to both law firm attorney(s) and Corporate inside counsel assigned to the matter/project. Clicking on hyperlink will display attorney profile.
Matter/Project/Content Calendar will be used to keep track of deliverables and due dates.
History Tab will display connection history and hours worked on content for each team member. This tab will only be visible to Workspace creator.
Reporting Tab will display history of changes. This tab will only be visible to the Workspace creator.
Each Tabs/Labels/Views will be customizable.
Search requests will be completed in two ways: (a) using hyperlink name or (b) content search. Content search requests will be directed to originating Agent Server for each content owner. Agent Server will query DMS repositories of each content owner using the DMS UserId and return consolidated listing of results.

### Workspace Creation (0800)

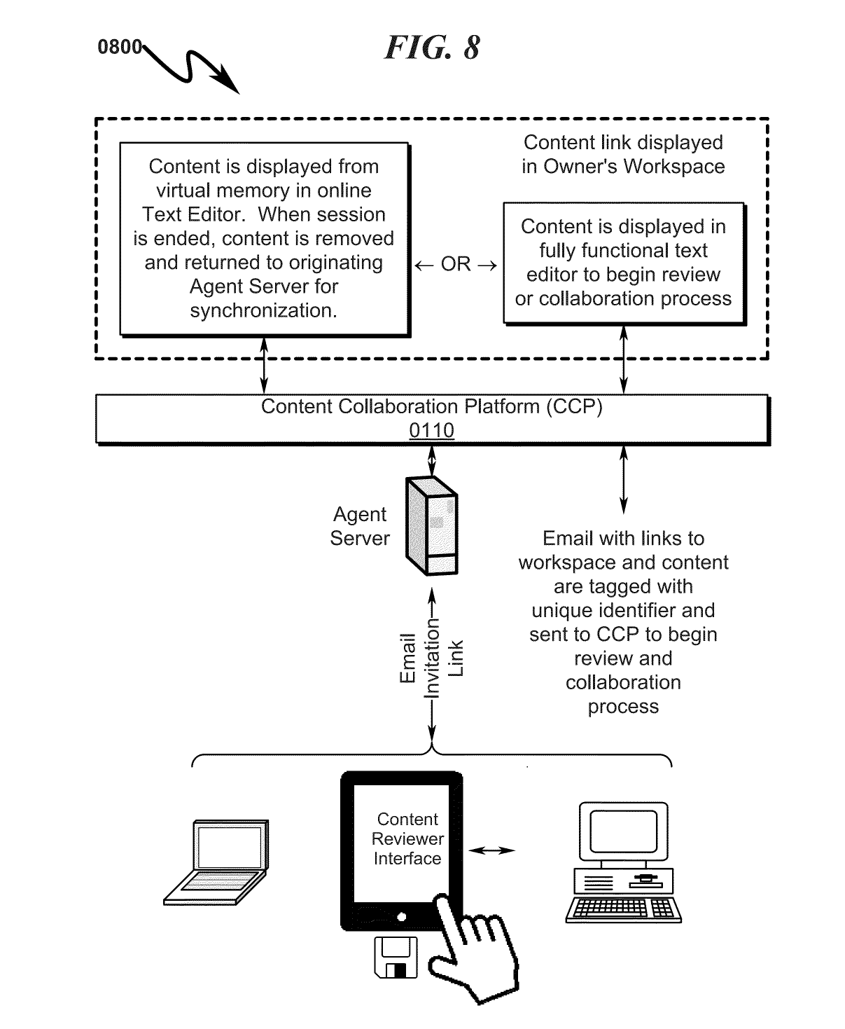

As described herein and further detailed in FIG. 8 (0800), the system (0100) provides mechanisms that enable one or more owners to create workspaces containing documents, folders of documents, content, and other information that may be shared over a network with one or more reviewers. Through integration with the CCP (0110), certain embodiments provide a secure manner of providing customized collaboration where a reviewer may have access to review and/or edit documents in a workspace, but may be prevented from obtaining a copy of the modified document after a communication session with the CCP (0110) ends. The owner's system, however, is configured to synchronize with the owner's local storage system all changes made by all reviewers (whether done simultaneously or at different times) through the CCP (0110). Thus, unlike conventional document sharing systems, where information may be maintained at a web-based location, and overwritten when changes are made, the disclosed embodiments provide methods and systems that securely maintain an original document at the original owner's storage system, along with any synchronized updated versions of the document. Moreover, through the workspace concepts disclosed herein, owners can configure and implement collaboration sessions where content can be selectively shared without losing control of the shared content in the workspace to reviewers. These and other aspects of the disclosed embodiments may be performed by one or more of the components of system (0100). The exemplary processes that may be performed by the components are described below.

### Exemplary Alternate Processing Methods (1100, 1200)

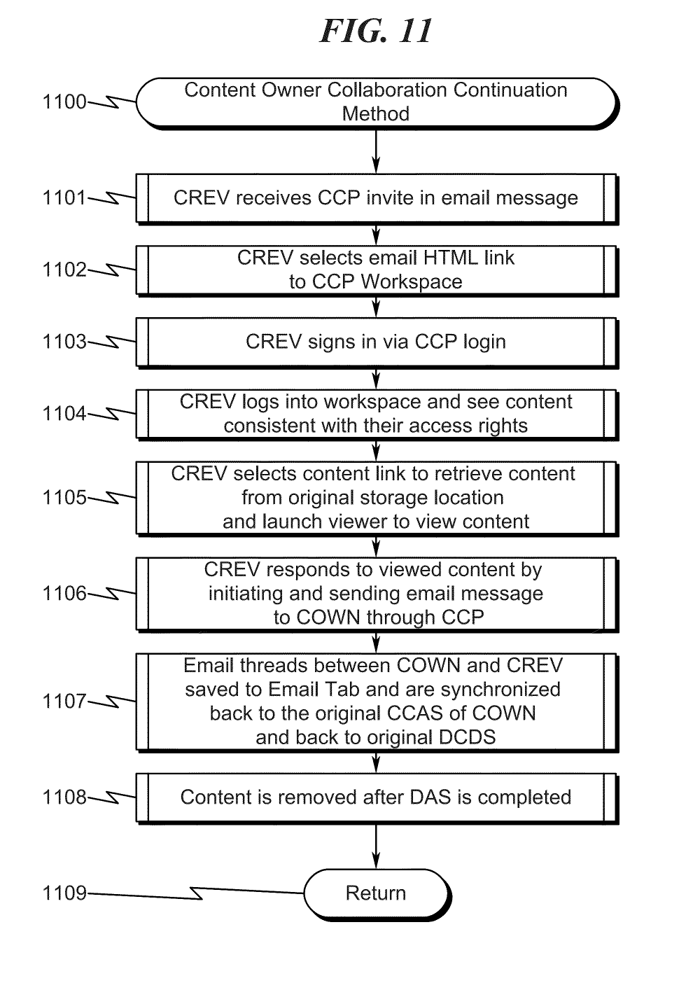

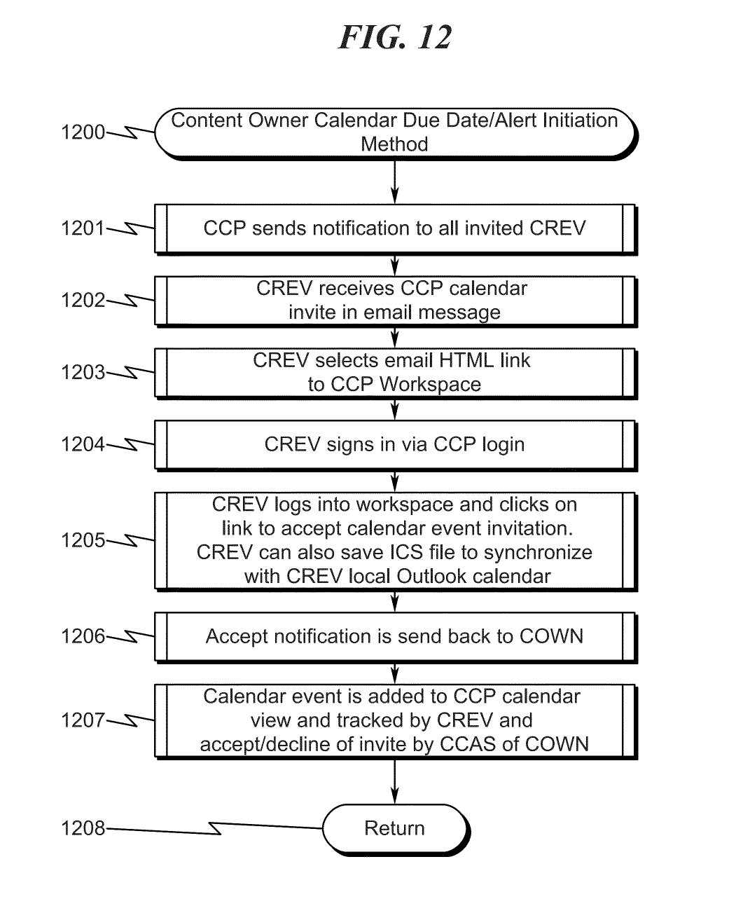

The present invention may incorporate a number of other flows and processing steps associated with CCP (0110) behavior. Two of these are generally illustrated in FIG. 11 (1100) that illustrates a Content Owner Collaboration Continuation Method (illustrating a COWN collaboration process flow) and in FIG. 12 (1200) that depicts a Content Owner Calendar Due Date/Alert Initiation (permitting a COWN to associate alarms with document review). One skilled in the art will recognize that other extensions and combinations of the methods detailed herein are possible given the present invention teachings regarding synchronized document access and distributed document access by COWN and CREV entities via the CCP infrastructure.

### Exemplary Workspace Creation Method (1300)

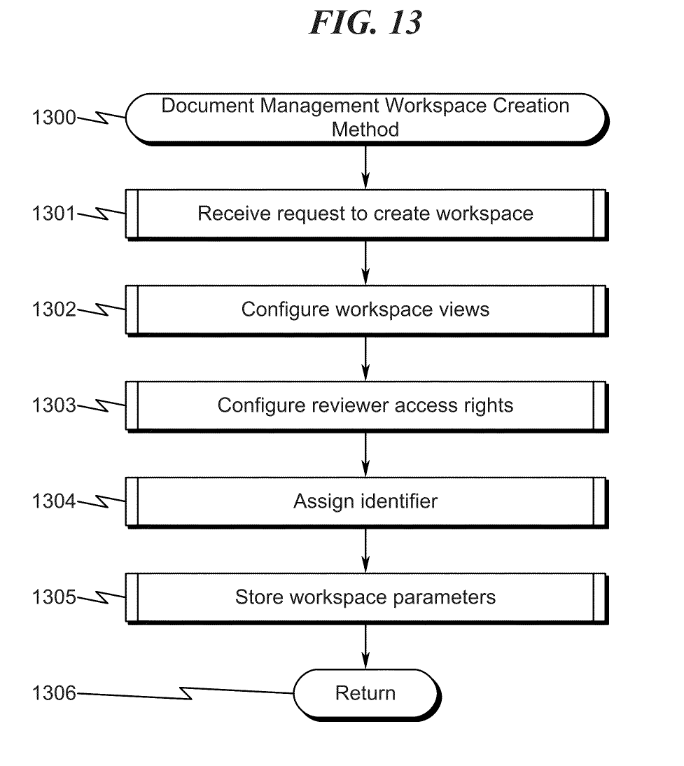

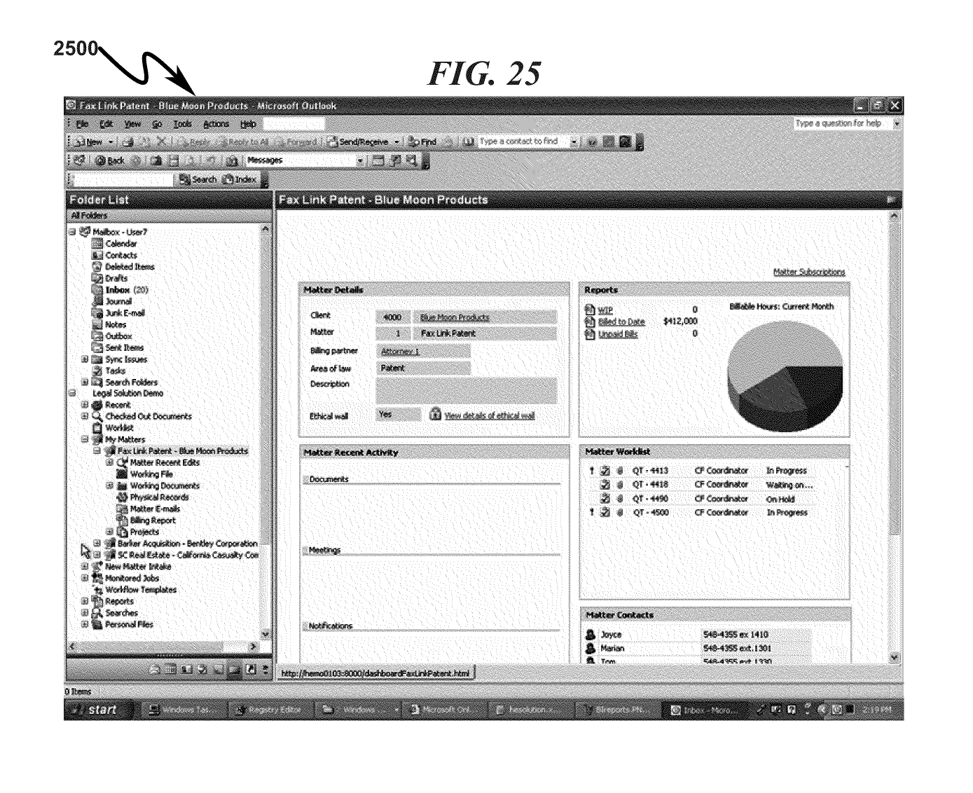

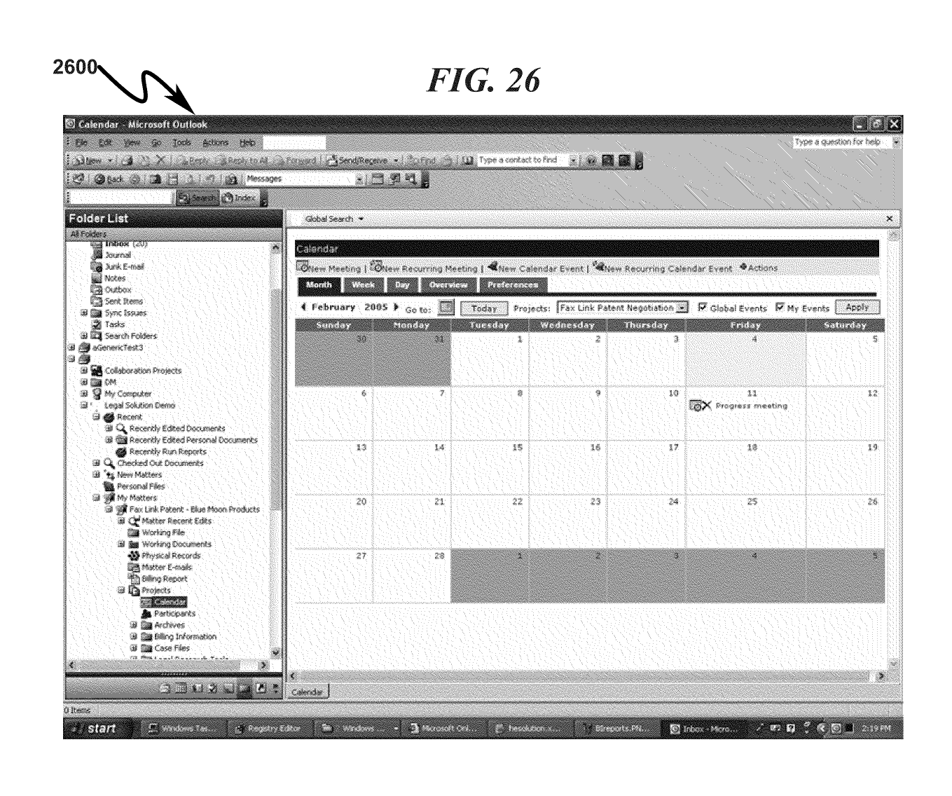

FIG. 13 (1300) depict an exemplary flowchart illustrating an exemplary workspace creation method (1300) that may be performed by one or more components of system (0100) consistent with certain disclosed embodiments. This method generally incorporates the following steps:
(1) Receive request to create workspace (1301). In one embodiment, the workspace creation method (1300) may begin with agent server (0226) receiving a request to create a workspace from client application (0223) (1301). Depending on the type of application, the request may be generated automatically by client device (0222), or it may be generated in response to a user command when running application (0223). For example, application (0223) may include an Add-On, menu option, or hot key sequence that initiates a request to create a workspace. FIG. 3 (0300) illustrates an exemplary system with a client (e.g., client (0120)) that includes, among other things, four client applications (0223-1, 0223-2, 0223-3, 0223-4) with “create workspace” options.
(2) Configure workspace views (1302). Agent server (0226) may then provide options to client (0222) to present to a user operating client (0222) to configure views for the workspace (1302). In one embodiment, agent server (0226) may provide options to enable a user to select tabs, and areas in workspace that are specific to that user. For example, agent server (0226) may provide options for the user to include one or more of the tabs described above in connection with FIG. 25 (2500) and FIG. 26 (2600). Agent server (0226) may receive input from client (0222) indicating the types of views for the workspace and stores the information.
(3) Configure reviewer access rights (1303). Agent server (0226) may also provide options to client (0222) to present to the user operating client (0222) to configure reviewer access rights to views of the workspace (1303). In one embodiment, agent server (0226) may provide options to allow the user to identify and select access rights to certain views within the workspace for one or more reviewers. For example, a user may allow certain reviewers associated with a business entity access to all views in the workspace, while restricting access by other reviewers associated with the same business entity to one or more of the views of the workspace. The disclosed embodiments also enable the user to configure access rights based on different business entity relationships, geographical locations, domain name characteristics, and any other type of characteristics relating to reviewers or groups of reviewers.
(4) Assign identifier (1304). The agent server (0226) assigns a unique identifier to the workspace that is provided to the CCP (0110).
(5) Store workspace parameters (1305). Once the workspace parameters (e.g., access rights, views, and other aspects such as look and feel, controls, tagged with unique identifiers, etc.) are configured, agent server (0226) stores the workspace parameters (1305) for later use when the workspace is accessed for rendering by the CCP (0110).

### Exemplary Workspace Update Method (1400)

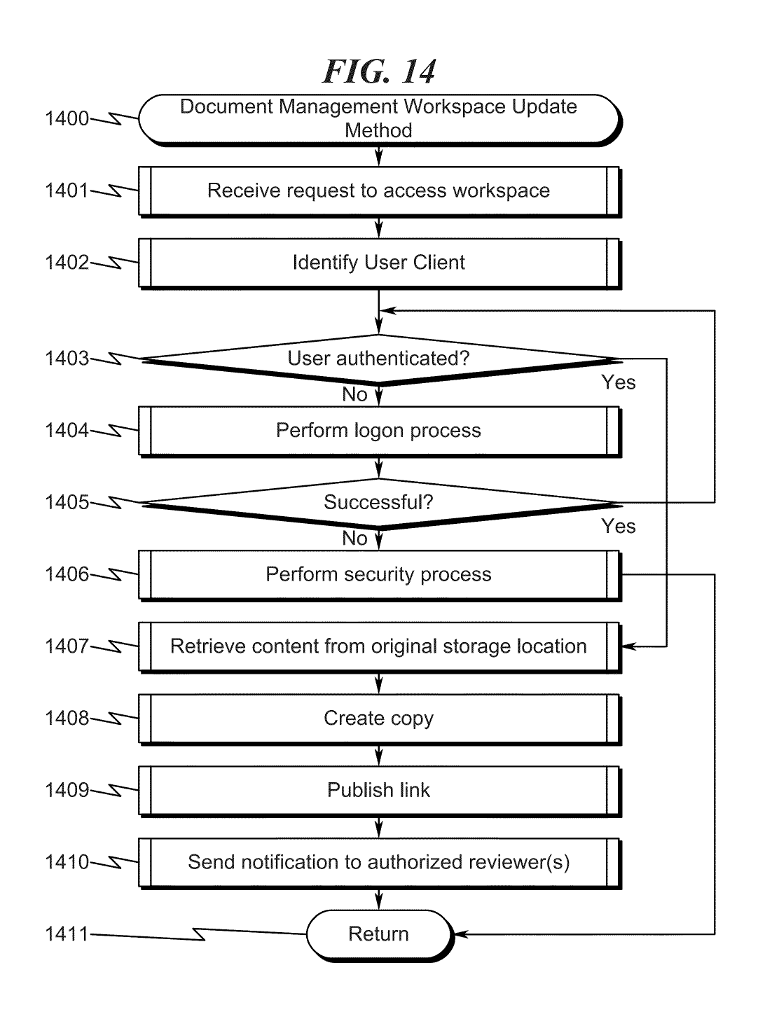

FIG. 14 (1400) depicts a flowchart illustrating an exemplary workspace update method (1400) consistent with certain disclosed embodiments. This workspace update method may be performed by one or more components of system (0100). In one embodiment, an owner (e.g., client (0120)) may publish a content link to a shared workspace in order to share content for review and/or editing by authorized reviewers (e.g., client (0130)). The owner may share various types of content on the shared workspace (1300), including but not limited to documents, folders of documents, database entries, calendar entries, and any other form of content or information (collectively referred to herein as Data Content and/or Documents (DCDS)). In one embodiment, the owner may initiate the workspace update method (1400) after creating a new document or folders of documents, or after updating a document through client application(s) (0223).

### Method Steps (1401)-(1407)

To share content, the owner may access the workspace, for example, by initiating a request at client device (0222). In one embodiment, agent server (0226) receives the request to access the workspace (1401). Agent server (0226) may then attempt to identify the owner (1402). Agent server (0226) may then determine whether the owner is authorized to access the workspace based on the user's credentials (1403). If so, the method continues (1407). If not, agent server (0226) may initiate a logon process (1404), where the agent server (0226) requests and receives from the owner credentials (e.g., a username and/or password) for accessing the workspace. If the owner's user credentials do not match any authorizations (1405), agent server (0226) denies the owner access (1406). However, if the owner provides the proper credentials, the method continues (1407).

### Method Steps (1408)-(1410)

The content owner may then select content (e.g., a document, folder of documents, etc.) from an original storage location in client storage (0224) to attach to the workspace (1407). In one embodiment, client storage (0224) may perform processes that create a copy of the original selected document to ensure the original document is maintained in the original source location in client storage (0224). Client storage (0224) may create a collaboration document (see e.g., FIG. 3 (0300)) for this purpose. Agent server (0226) may then create and store a copy of the content from client storage (0224) (1408). In certain embodiments, software processes executed in agent server (0226) and client storage (0224) may interface and communicate to facilitate the copying of the selected document to agent server (0226). In certain embodiments, client storage (0224) and agent server (0226) each perform respective processes that create entries in edit history tables maintained by each of these components that provide a log record of the copy operations of the document (or folder of documents). The log record may include a date and timestamp of the transaction involving the copy of the document (or folder(s)) to agent server (0226) for inclusion in the workspace and the identifier relating to the client (e.g., client (0120)) and/or user that initiated the transaction.

### Workspace Synchronization

Agent server (0226) may then synchronize the newly added document to the workspace with the CCP (0110). In one embodiment, agent server (0226) may publish a link to the copy of the document in the workspace on the CCP (0110) (1409). Agent server (0226) may also send a notification to authorized reviewer(s) that indicates the document has been added to the workspace (1410). In one embodiment, agent server (0226) may send a notification email to authorized reviewers, alerting them to the presence of the new content available on the shared workspace for review and/or editing. In one embodiment, the owner may initiate the email notification through client application (0223). For example, as shown in FIG. 3 (0300), client application (0223) may include mechanisms (ribbon invite options, right-click options, etc.) that enable a user working with application (0223) to invite one or more reviewers to access the document (or folders) that has been added or modified in the workspace.

### Workspace Links

In certain embodiments, the email may contain a link to the workspace so that reviewers may log into the workspace to access the shared content through the published link. In other embodiments, the email may contain a link to the workspace provided by the CCP (0110). The workspace rendered by the CCP (0110) may include a link to the copied document hosted by agent server (0226), which may be displayed in virtual memory for review and/or editing, permitting a reviewer to review and/or edit content in a browser or web-based format. Thus, consistent with certain embodiments, the shared content may not be stored at the CCP (0110). In these embodiments, only a published link passes beyond the owner's client (e.g., client (0120)) through, for example, a firewall (0421, 0431), leaving the owner in sole control over the shared content except for any authorizations and access rights provided to one or more reviewers.

### Activity Logging

In certain embodiments, agent server (0226) may generate activity entries which are stored in an activity log of database tables maintained by agent server (0226). Agent server (0226) may generate these entries whenever a content link is published, notified, accessed, added, saved after editing, closed, or at any other event selected by a user at the time of creating updating, or editing a workspace or publishing a content link. In certain embodiments, the entries may store the following items of information for each transaction with a content link: date, timestamp, user ID, user email address, or any other item of information pertaining to the owner, reviewer, access rights, or content link. For example, the activity entries may also include information about the content link including the linked content's size, owner, version, etc., including information pertaining to any edits or changes made by reviewers or owners. Depending on user authorizations and access rights, the CCP (0110) may provide, through agent server (0226), access by reviewers to activity logs consistent with various disclosed embodiments of the invention. Additionally, client storage (0224) may create and update activity logs when an updated version of shared content is synchronized consistent with various disclosed embodiments of the present invention.

For example, agent server (0226) and client storage (0224) may be configured to create log entries of the notification in their respective edit history tables. (See e.g., FIG. 3 (0300), edit history). The log entries may include a date and timestamp of the notification transaction and an identifier of the user or client that initiated the transaction. Further, agent server (0226) may create an activity record of the email address for each recipient of the notification within an invitation table maintained by agent server (0226). Agent server (0226) may also associated the notification activity record with the email record maintained in the edit history table of agent server (0226).

### Collaboration Review Method (1500)

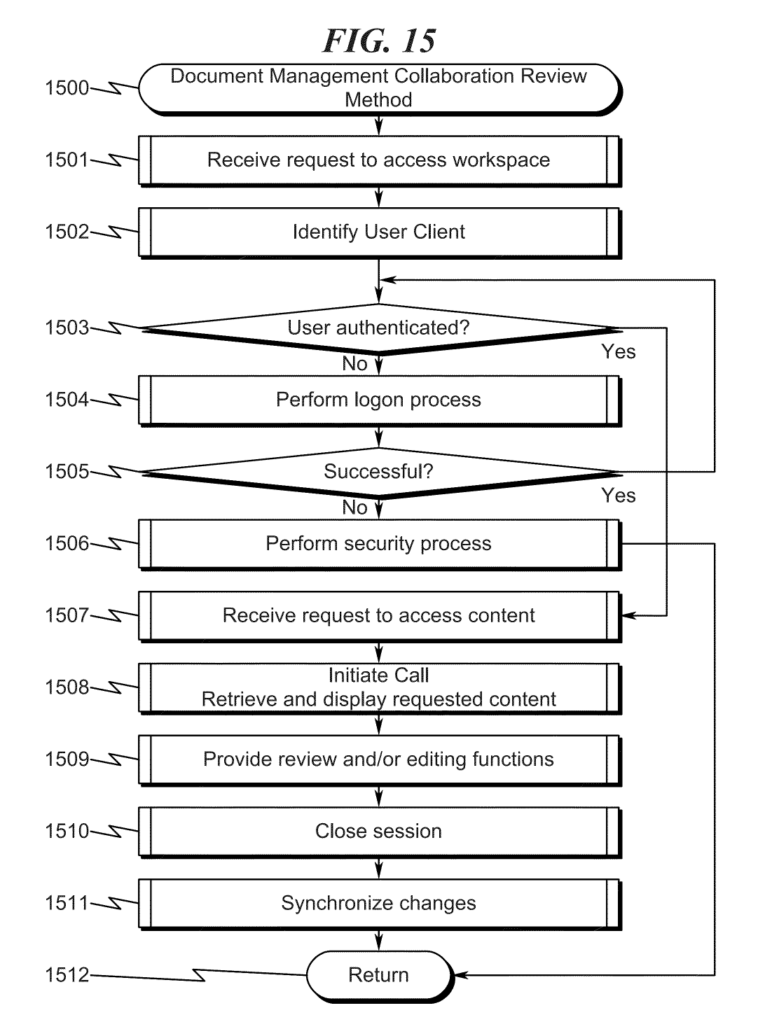

FIG. 15 (1500) illustrates a flowchart depicting an exemplary collaboration review method, consistent with certain disclosed embodiments of the present invention. This method may be performed by one or more components of system (0100).

In one embodiment, a reviewer (e.g., client (0130)) may receive a request to access a workspace from agent server (0226) of an owner in accordance with the notification processes described above in connection with FIG. 14 (1400). In one aspect of the disclosed embodiment, a reviewer may initiate a request to the CCP (0110) to access the workspace identified in the notification (or any workspace that the user may wish to attempt to access).

The method (1500) may also be performed for owners attempting to access a workspace through the CCP (0110). The CCP (0110) may receive the request provided by a client (e.g., client (0130)) over the computer network (0101) (1501). In one embodiment, the reviewer may initiate the request at client device (0222). In another embodiment, a user may open a notification email and initiate a request to access the workspace through the link in the email. Upon receiving the request, the CCP (0110) may attempt to identify the user (1502). The CCP (0110) determines whether the user is authorized to access the workspace (1503). If so, the CCP (0110) may grant the user access to the workspace and the method continues (1507). If not, the CCP (0110) may initiate a logon process (1504), where it requests and receives credentials from the user (e.g., username and/or password). If the CCP (0110) determines that the user's user credentials do not match any authorizations (1505), the CCP (0110) may deny access (1506). If the credentials do match, the method continues where a communication session is established with the user (1507) and the CCP (0110).

Once the user is authorized, the CCP (0110) may collect the information relating to the requested workspace from agent server (0110), and render the workspace with views based on one or more rules that take into account the requesting user's access rights previously configured by the workspace creator. In one example, platform collaborator (0110) may receive decisions of access rights by agent server (0226) associated with the owner of the workspace that identifies the views and options that the user is allowed to receive via the CCP (0110). Upon successfully accessing the workspace, an authorized user may then review the content shared on the workspace (1508) pursuant to that user's access rights. The user may, for example, access and view the email, calendar, news, history, reporting, activity log, an instant messaging features, links to other workspaces, and tabs for other matters, features, or projects.

The CCP (0110) may receive a request to access content selected by the user (1507). The requested content may be a request to access a document via a content link displayed in the workspace. In response to receiving an indication that the user selected one of the document links, the CCP (0110) may initiate a call to agent server (0226) of the content owner to establish a connection to display the content of the requested document through the CCP (0110) (1508). In one embodiment, the document and its content remains at the owner's client, and the CCP (0110) stores the content in virtual memory and renders the content via web-based display technologies to a browser or similar software at the reviewer's client system. At no time is content copied to the reviewer's system.

Based on the access rights for the requested content, the CCP (0110) may provide application services through the web-based service such that the reviewer may view the shared content displayed through virtual memory by the CCP (0110) (1508). In certain embodiments, the CCP (0110) may display the content with a text and/or data editor similar to those offered by client application(s) (0223), permitting the reviewer to review and/or edit the content in accordance with the user's access rights (1509). The CCP (0110) receives input from reviewer regarding any changes to the content (e.g., changes to text in a document, etc.) and maintains in virtual memory the changes in accordance with the document editing features offered by the platform. The CCP (0110) may receive an indication once the reviewer has completed collaboration activities (e.g., log off), and in response closes the communication session with the reviewer (1510). The CCP (0110) may initiate synchronization processes with agent server (0226) of the owner to provide activity information and changes to agent server (0226) and deletes from virtual memory all information relating to the requested, viewed, and edited content for the reviewer's workspace (1511). In one embodiment, a container is provided from the CCP (0110) to agent server (0226) over the computer network (0101). In another embodiment, agent server (0226) may receive an indication that synchronization is required and retrieves the updated information over the computer network (0101).

### Exemplary Synchronization Method (1600)

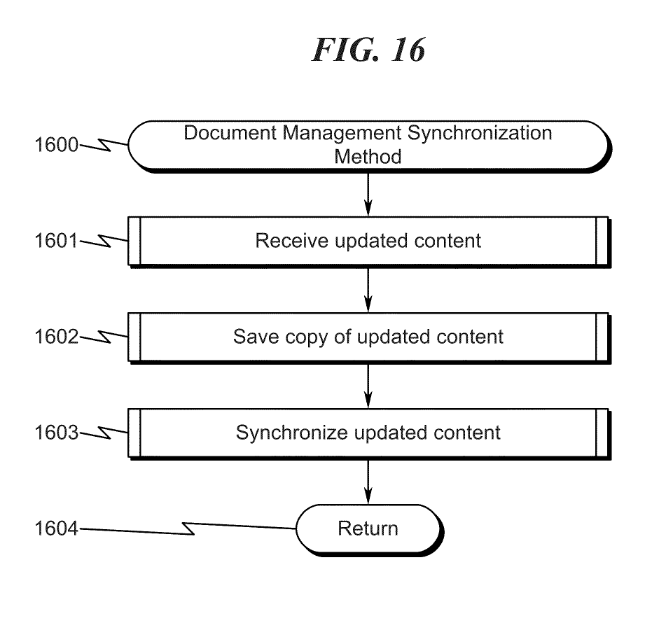

FIG. 16 (1600) depicts a flowchart illustrating an exemplary synchronization method consistent with several preferred invention embodiments. In one embodiment, agent server (0226) may receive synchronization information from the CCP (0110) following a collaboration session with a reviewer, such as that described above in connection with FIG. 15 (1500). Agent server (0226) may receive the updated content for a document or set of documents (1601) and save a copy of the content and changes in memory (1602). In one embodiment, agent server (0226) saves all of the changes to a Changes Table that is associated with the email address of the Reviewer that made the changes. Agent server (0226) may also create an activity entry to log the save operation to the Edit History Table in an agent server (0226) database with the date and timestamp of the transaction, along with the email address of the reviewer that initiated the transaction.

Agent server (0226) may then synchronize the changes with client storage (0224) (1603). In one embodiment, agent server (0226) communicates with client storage (0224), which creates a new document version (Collaboration Document) associated with the original document that was edited, which may or may not be in a proprietary file format, and sets security access rights to client storage (0224) UserId relating to the original transaction that created the document or content. Agent server (0226) may then synchronize the changes to the created Collaboration Document and create several activity entries to
log the create operation to a versions table;
log the save operation to the edit history table with the date and timestamp of the transaction using the UserId from the original transaction; and
log the email address of the reviewer that made the changes to the document.

Client storage (0224) also logs the save operation in its edit history table with the same data and timestamp and UserId information, and logs the create operation in corresponding version table maintained by client storage (0224).

In certain embodiments, after agent server (0226) has synchronized the updated content to client storage (0224), agent server (0226) may republish the content link on the workspace for subsequent access by authorized reviewers. In certain embodiments, this republished link may display the updated version with changes in redline, or in other embodiments without redline. The CCP (0110) may provide services that enable reviewers to view changes to a shared document made by multiple reviewers (and the owner) in real-time.

With certain documents, an owner may desire to share the latest available information in real time with various reviewers. In accordance with certain embodiments of the invention, agent server (0226) and/or client storage (0224) may be configured with software that when executed automatically updates workspaces whenever content is updated in a document by an owner. For example, upon completion of changes to a document via client application (0223), client device (0222) may notify client storage (0224) that a change was made to the document. In response, client storage (0224) may initiate synchronization processes where a Collaboration Document is created that corresponds to the original document (see e.g., FIG. 3 (0300)) and the changes are synchronized with agent server (0226) for updating the links for that document in any appropriate workspaces.

In certain embodiments, after agent server (0226) has synchronized the updated content to client storage (0224), agent server (0226) may republish the content link on the workspace using a ‘new content’ flag indicator as an alert that the content has changed and is available for subsequent access by authorized reviewers.

As described above, certain disclosed embodiments permit single or multiple owner(s) (e.g., client (0120)) and single or multiple reviewer(s) (e.g., client (0130)) to connect to the CCP (0110) for sharing documents, folders of documents, content, etc., in various combinations of shared workspaces. Certain embodiments also provide for the synchronization of, for example, documents between the client storage (0224) and agent server (0226) of an owner (e.g., client (0120)) with the document links published to the workspaces on collaboration (0110), such that reviewers (e.g., client (0130)) that access document links included in the workspace may access up-to-date content, and owners accessing documents stored on their own systems (e.g., client (0120)) may also have access to up-to-date content. In further embodiments, owners may configure user authorizations and access rights, limiting the rights of reviewers to maintain security and control over the owners' documents. In still further embodiments, the disclosed embodiments may host and provide various other applications and functionalities in conjunction with the collaboration, synchronization, and security systems and processes described above.

Other embodiments will be apparent to those skilled in the art from consideration of the specification and practice of the features disclosed herein. Further, the sequence of processes steps disclosed in connection with the figures are not intended to be limiting. Additional or fewer steps may be implemented in a manner consistent with certain features of the disclosed embodiments. The disclosed embodiments may be implemented in a number of environments to facilitate collaborations in real time over the Internet where control is retained by an owner over created documents and content. For example, owners may restrict the rights of reviewers to single-access sessions, where after a reviewer completes a communication session where they access and possible edit documents via a link on a workspace the link may be deleted—not updated and republished. In other embodiments, owners may restrict the rights of reviewers by only permitting access to static links, where reviewers may access links to the version of a document originally shared by an owner on the workspace, but this link may not be updated and republished as owners and reviewers with greater access rights update the document over time. Various disclosed embodiments of the present invention may also be implemented in different interactive contexts. For example, a business entity owner that is a client of a law firm may create one or more workspaces to share documents with the law firm relating to matters for the client, permitting the law firm's staff and attorneys to review and update documents while retaining a desired degree of control over those documents. Aspects of the disclosed embodiments may enable the staff and attorneys to create and share their own documents for the client to review, sign, etc. As another example, various internal corporate departments may collaborate and share documents among each other by utilizing certain of the disclosed embodiments, enabling participating departments to access the most up-to-date information without losing control over their own shared content, generating increased operations efficiency. Certain embodiments may also be utilized in an educational context, facilitating teachers and students in sharing ideas and information over a CCP (0110) in a safe and secure system, but allowing the educators to prevent the students from obtaining copies of collaborated documents through the CCP (0110). Thus, reviewers and owners may be associated with the same entity or may be associated with different entities. As another example, certain embodiments may also be utilized in an negotiation of sales partnership contracts, facilitating both companies in negotiating terms of the agreement over a CCP (0110) in a safe and secure system without losing control over their own shared content, generating increased operations efficiency. Also, in these or any other interactive contexts, multiple CCPs (0110) may be implemented that provide collaboration features consistent with the disclosed embodiments between the same or different owners and/or reviewers. It is intended that the specification and examples be considered as exemplary only, with a true scope and spirit of the disclosed embodiments being indicated by the following claims.

### Exemplary Embodiment CCP Workflow (1700)-(2400)

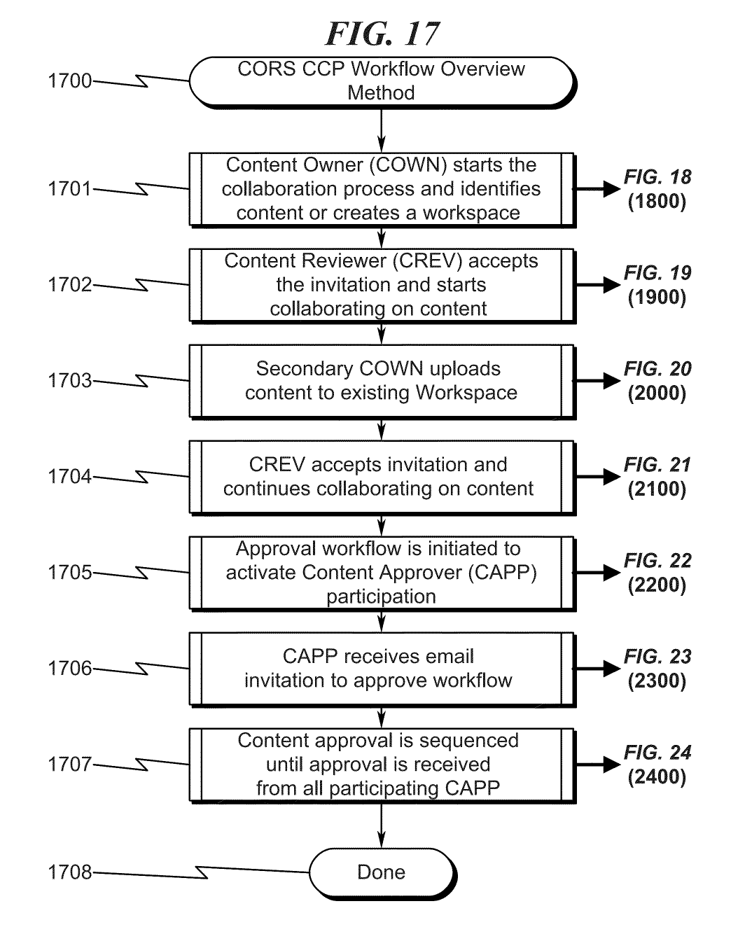

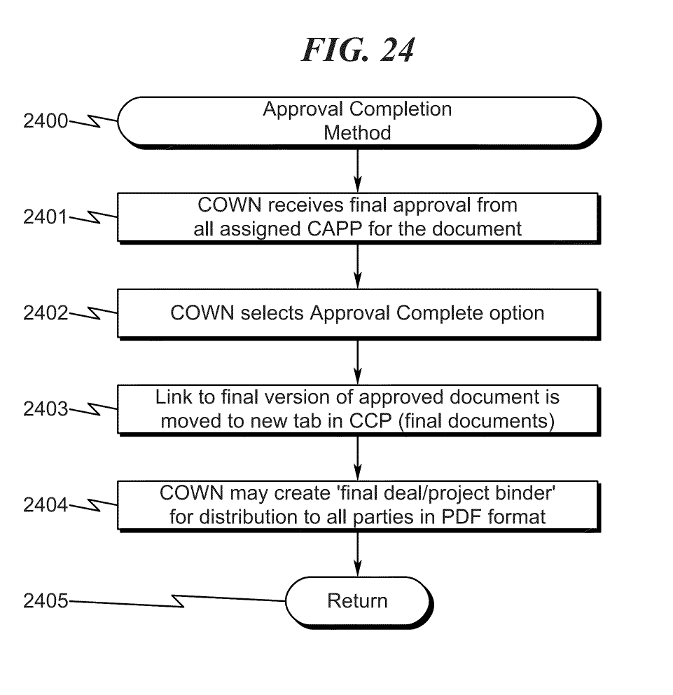

The present invention may be implemented in a wide variety of application contexts, but some are preferred. The CCP workflow associated with one preferred embodiment is generally illustrated in the flowcharts depicted in FIG. 17 (1700)-FIG. 24 (2400) and discussed in detail below.

### Overview (1700)

The CCP workflow overview is depicted in FIG. 17 (1700), wherein the workflow steps include the following:
(1) Content Owner (COWN) starts the collaboration process and identifies content or creates a workspace (1701);
(2) Content Reviewer (CREV) accepts the invitation and starts collaborating on content (1702);
(3) Secondary COWN uploads content to existing Workspace (1703);
(4) CREV accepts invitation and starts collaborating on content (1704);
(5) Approval workflow is initiated to activate Content Approver (CAPP) participation (1705);
(6) CAPP receives email invitation to approve workflow (1706); and
(7) Content approval is sequenced until approval is received from all participating CAPP (1707).

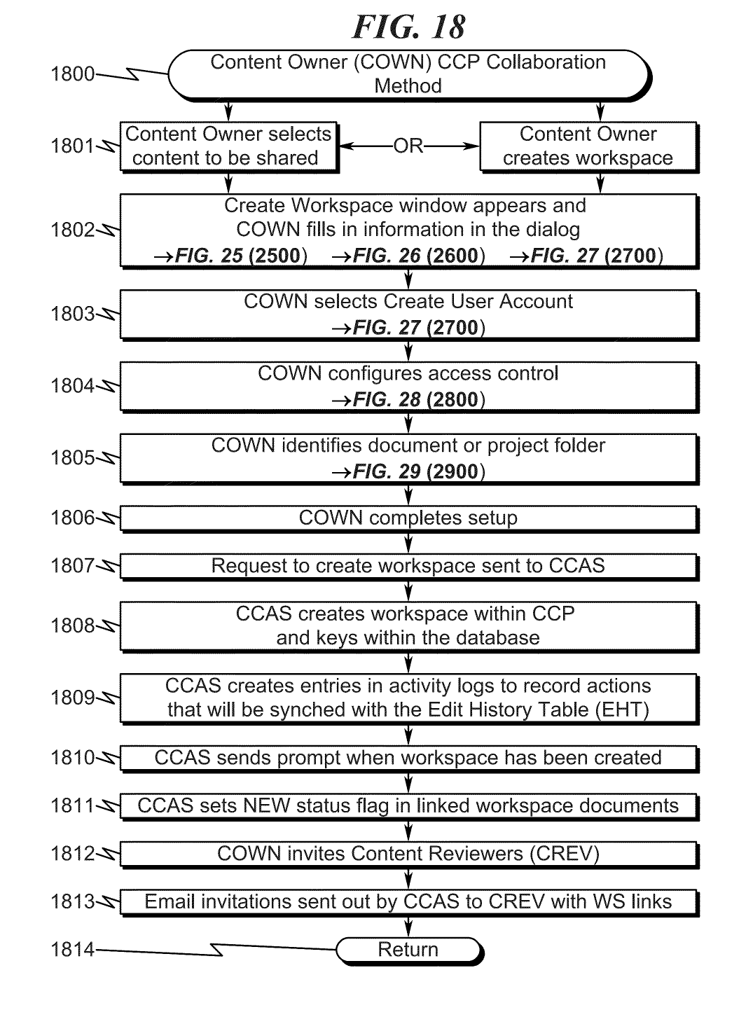

This general method may be augmented by the various elements described herein to produce a wide variety of invention embodiments consistent with this overall design description. More detail on each of these workflow steps is provided in the flowcharts depicted in FIG. 18 (1800)-FIG. 24 (2400) and discussed in detail below.

### Content Owner (COWN) Collaboration Method (1800)

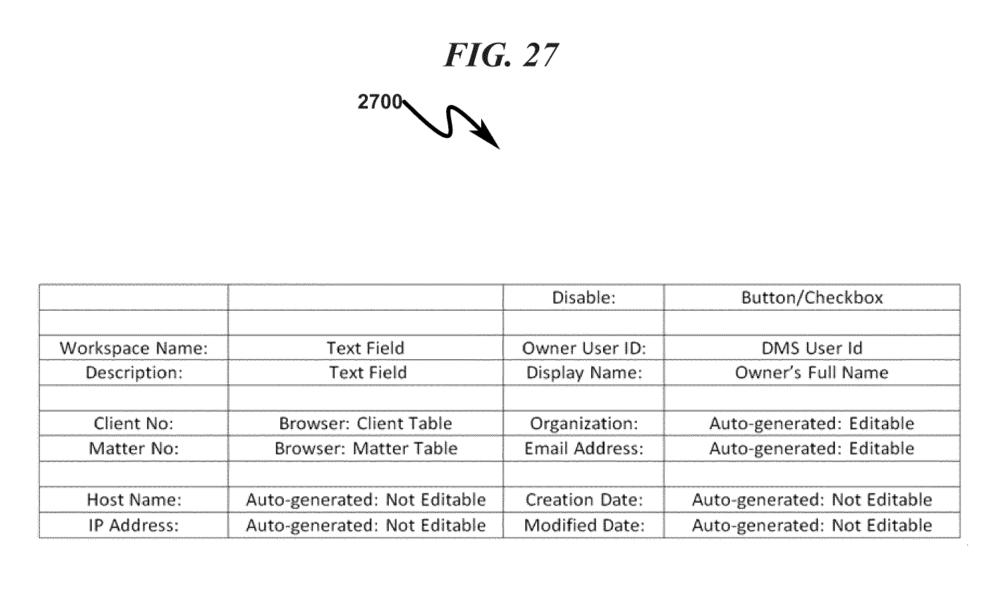

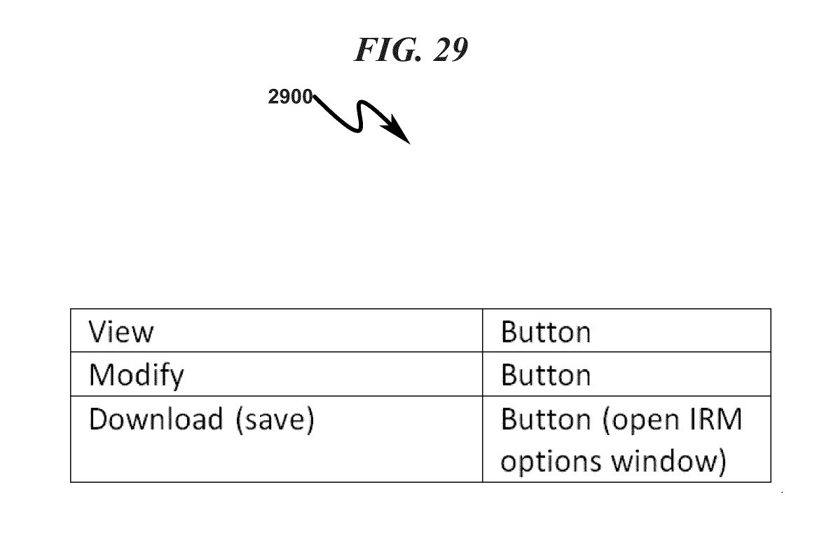

An exemplary approval initiation method (Content Owner starts the collaboration process—One-Way, Single Connection) is generally depicted in FIG. 18 (1800), wherein the workflow steps include the following:
(1) Content Owner will identify content that is to be shared—either a single document or a project folder containing multiple documents (from within their DMS/MICROSOFT OUTLOOK® Add-in, etc.) and right click to create a workspace; or Content Owner creates a workspace by clicking the Create Workspace button (on the CCP Ribbon or MSWord Add-in, etc.) (1801);
(2) The Create Workspace window will appear. Content Owner will fill in information in the dialog and click OK to complete and close creation window (1802);
(3) Content Owner will click the Create User Accounts button and create user window will appear. Content Owner will fill in information and click OK to complete and close creation window (Content Owner will choose from a list of authorized users per authorized connection (FIG. 27 (2700)) (1803);
(4) Content Owner will click the Access Control button and access control window (FIG. 29 (2900)) will appear. Content Owner will choose access option and click OK to complete and window will close (1804);
   (a) View will only allow a Content Reviewer to open the document and view the contents. The online editor will not launch.
   (b) Modify will allow a Content Reviewer to open the document, view the contents and make edits and/or suggested changes using the online editor. Once the changes have been completed, the changes will be synchronized back to the original CC Agent Server of the Content Owner to its original source.
   (c) Download will send a request to the original CC Agent Server for IRM Service.
(5) If Content Owner created workspace from either CCP client or Word add-in, it will require Content Owner to identify a document or project folder containing multiple documents by clicking the Content button and attach content window will appear. Content Owner will choose a document or project folder containing multiple documents to be linked to workspace. (1805);
(6) Content Owner will click OK to complete setup (1806);
(7) Request to create a workspace (containing the information above) will be sent to the CC Agent Server (1807);
(8) The CC Agent Server will create the workspace within the CCP and create several keys within the database (1808);
   (a) ‘GUID’ for the ‘Workspace’;
   (b) ‘UID’ for host name of CC Agent Server who initiated the request;
   (c) ‘UID’ for each Content Reviewers (full name) and email addresses;
   (d) ‘UID’ access rights granted to Content Reviewers;
   (e) ‘UID’ for each document/content being shared; and
   (f) ‘UID’ to set status of each document/content being shared;
(9) CC Agent Server will also create entries in the activity logs to record actions that will be synched with Edit History table of DMS (1809);
   (a) The copy operation of either the single document or each document contained within the project folder to the Edit History tables in the DMS database and the CC Agent Server database with the current date and timestamp of the transaction, along with the DMS UserId that initiated the transaction;
   (b) The email operation of either the single document or each document contained within the project folder to the Edit History tables in the DMS database and the CC Agent Server database with the current date and timestamp of the transaction, along with the DMS UserId that initiated the transaction;
   (c) The email address for each recipient is logged within the CC Agent Server database in the Email Invitation Table and associated with the email record in the Edit History table.
(10) CC Agent Server will send a prompt when workspace has been created (1810);
(11) CC Agent Server will set NEW flag in Status for each of the documents linked to the Workspace (1811);
(12) Content Owner will click Invite button to choose Content Reviewers to invite and send invitation. Invitation screen may need to be modified to include newly created ‘workspace’ that Content Reviewers are being invited to and rights to individual documents/content (1812); and
(13) Email invitation is sent out by CC Agent Server to Content Reviewers with link to workspace. Link will be to workspace, but should also include email address of Content Reviewer and password set by Content Owner to allow for easy login by Content Reviewer. (1813).

This general method may be augmented by the various elements described herein to produce a wide variety of invention embodiments consistent with this overall design description.

### Content Reviewer Start Collaboration Method (1900)

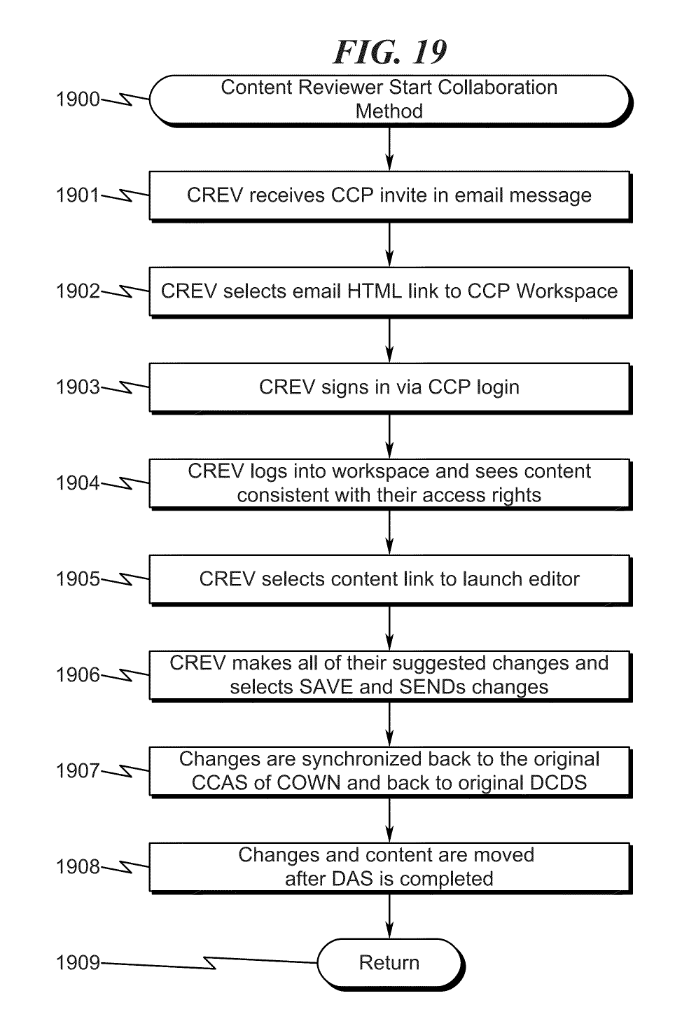

An exemplary approval initiation method (Content Reviewer accepts invitation and starts collaborating on content) is generally depicted in FIG. 19 (1900), wherein the workflow steps include the following:
(1) Content Reviewer receives a CCP invite in email message (1901);
(2) Content Reviewer clicks on email HTML link to Workspace in CCP (1902);
(3) Content Reviewer signs in via CCP login (1903);
(4) Content Reviewer logs into workspace and see content consistent with their access rights (1904);
(5) Content Reviewer clicks on one of the content links and online editor is launched (1905);
(6) Content Reviewer makes all of their suggested changes and chooses to save and send changes (1906);
(7) Changes are synchronized back to original CC Agent Server of Content Owner and back to original source (1907); and
(8) Changes and content are removed after session is completed (1908).

This general method may be augmented by the various elements described herein to produce a wide variety of invention embodiments consistent with this overall design description.

### Content Reviewer Continued Collaboration Method (2100)

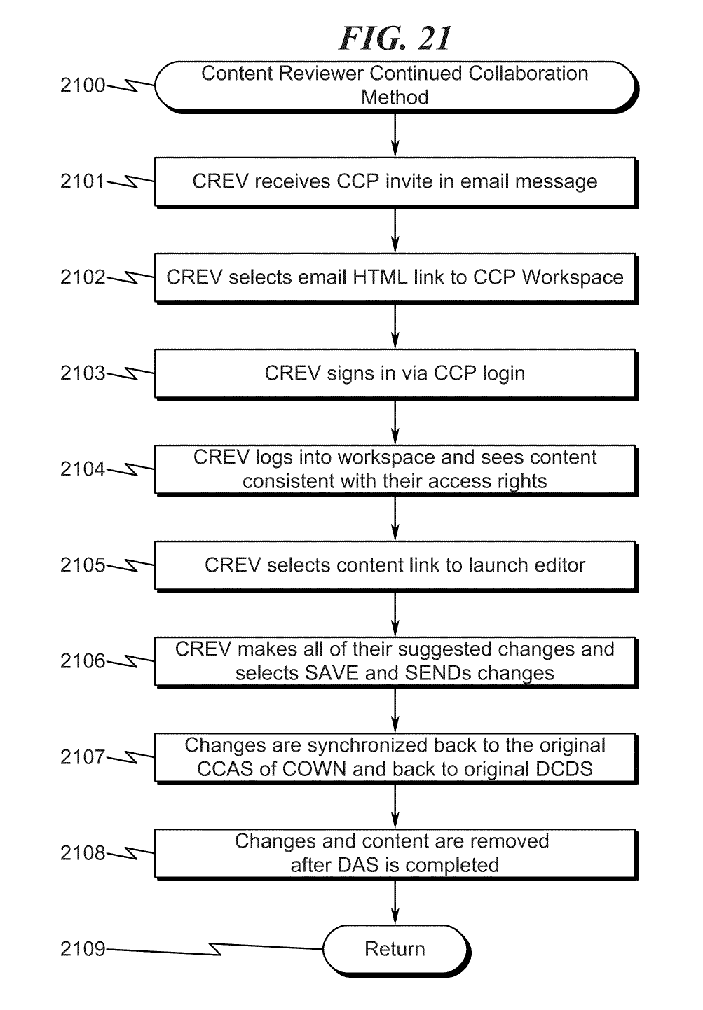

An exemplary approval initiation method (Content Reviewer accepts invitation and continues collaborating on content) is generally depicted in FIG. 21 (2100), wherein the workflow steps include the following:
(1) Content Reviewer receives a CCP invite in email message (2101);
(2) Content Reviewer clicks on email HTML link to Workspace in CCP (2102);
(3) Content Reviewer signs in via CCP login (2103);
(4) Content Reviewer logs into workspace and see content consistent with their access rights (2104);
(5) Content Reviewer clicks on one of the content links and online editor is launched (2105);
(6) Content Reviewer makes all of their suggested changes and chooses to save and send changes (2106);
(7) Changes are synchronized back to original CC Agent Server of Content Owner and back to original source (2107); and
(8) Changes and content are removed after session is completed (2108).

This general method may be augmented by the various elements described herein to produce a wide variety of invention embodiments consistent with this overall design description.

### Approval Initiation Method (2200)

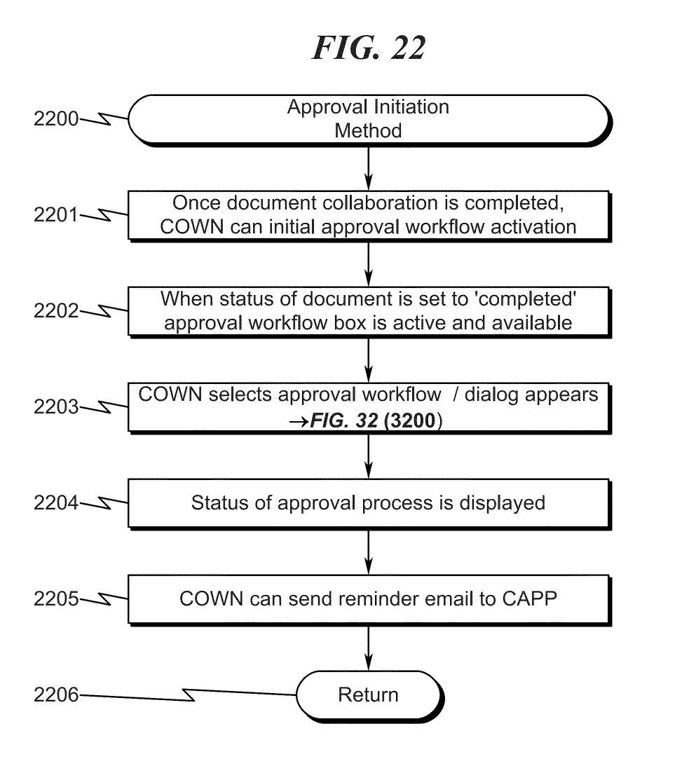

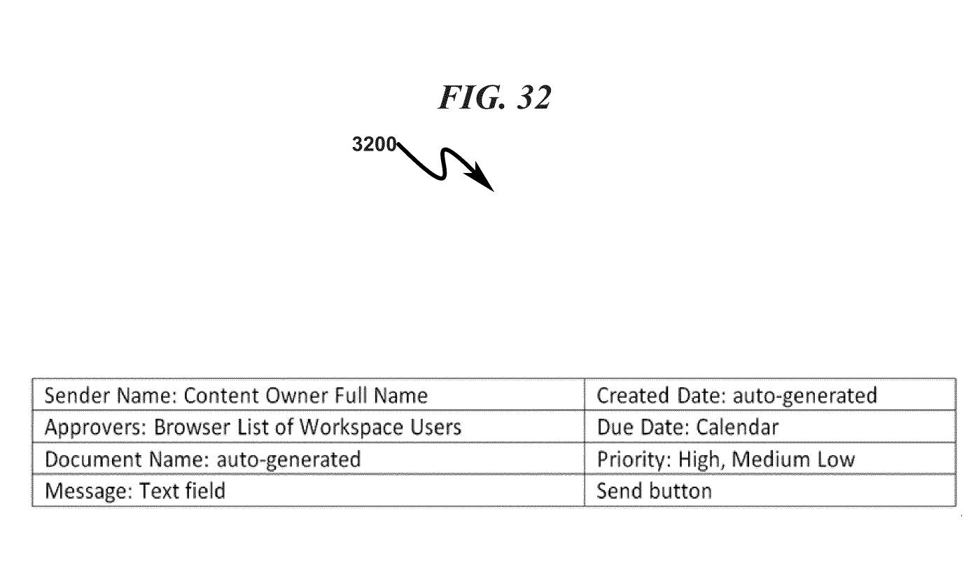

An exemplary approval initiation method (approval engine workflow once collaboration process has been completed) is generally depicted in FIG. 22 (2200), wherein the workflow steps include the following:
(1) Once collaboration process on any document has been completed, Content Owner can initial approval workflow by checking Approval Workflow checkbox. (2201);
(2) When Status of document has been set to ‘completed’ the Approval Workflow checkbox will become ‘active’ and the checkbox will be available for use (2202);
(3) Content Owner checks Approval Workflow checkbox and new create window (FIG. 32 (3200) will appear (2203);
(4) Status of Approval progress bar is set to 0% (List of Approvers and status of their approval will appear when mouse is hovered over progress bar) (2204); and
(5) Content Owner can also send a reminder email to any Approver by clicking on the Send Reminder icon or simply send an email by clicking the Send Email icon (2205).

This general method may be augmented by the various elements described herein to produce a wide variety of invention embodiments consistent with this overall design description.

### Approval Invitation Method (2300)

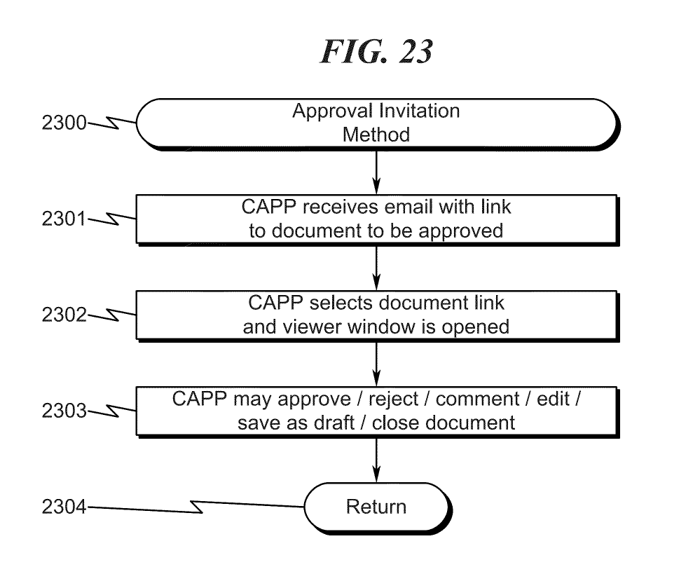

An exemplary approval invitation method (approver receives email invitation to approval workflow) is generally depicted in FIG. 23 (2300), wherein the workflow steps include the following:
(1) Approver receives email with link to document to be approved (2301);
(2) Approver clicks on document link and viewer window is opened (2302);
(3) Approvers have the following functionality available to them (2303):
   (a) Approve. This will complete the approval workflow and return response back to Content Owner.
   (b) Reject. This will complete the approval workflow and return response back to Content Owner.
   (c) Comment. This will open separate text box window for Approver to type in comment and return response back to Content Owner.
   (d) Edit. This will open online text editor and allow Approver to make additional changes to content.
   (e) Save as Draft. This will allow Approver to continue to review content and make changes before sending response back to Content Owner.
   (f) Close. This will close online text editor without saving any changes.

This general method may be augmented by the various elements described herein to produce a wide variety of invention embodiments consistent with this overall design description.

### Approval Completion Method (2400)

An exemplary approval completion method (completion of approval process) is generally depicted in FIG. 24 (2400), wherein the workflow steps include the following:
(1) Content Owner receives final approval from all of the assigned Approvers for the document (2401);
(2) Content Owner will click Approval Complete option (2402);
(3) Link to final version of approved document will be moved to new tab in CCP, Final Documents (2403); and
(4) The ability to create a ‘final deal/project binder’ will be available to the Content Owner for distribution to all parties in PDF format. (Request to CC Agent Server to convert each document to PDF Format using Binder functionality) (2404).

This general method may be augmented by the various elements described herein to produce a wide variety of invention embodiments consistent with this overall design description.

### Exemplary Workspace Dialogs (2500, 2600)

FIG. 25 (2500) and FIG. 26 (2600) illustrate an exemplary workspace dialog screens that CCP may provide in accordance with certain disclosed embodiments. The workspace dialogs (2500, 2600) may be a workspace that an owner has configured specific access rights to information for a reviewer to access, view, and possibly edit. Exemplary workspace dialogs (2500, 2600) may include a folders area that lists folders of documents that the reviewer is authorized to view and access. Workspace dialogs (2500, 2600) may also include a document list area that lists content links to accessible documents included in a selected folder from the folders area. A reviewer may access a particular document by selecting the appropriate link listed in the document list area of the workspace dialogs (2500, 2600). The calendar area (2600) of the workspace dialogs (2500, 2600) may provide a calendar view of items related to a particular matter that the reviewer has been authorized to view.

Other areas, information, tabs, etc. may be included in a workspace, and the example shown in FIG. 25 (2500) and FIG. 26 (2600) is not intended to be limiting to the disclosed embodiments. For example, in a workspace generated for collaboration between a corporate client and law firm, workspace views may contain the following elements: a Corporation Matter/Project Folder Listing, Content Tab, Email Tab, Legal Research Tab, News Tab, Team Contact Information, Attorney Profile Information, Matter/Project/Content Calendar, History and Reporting. The Corporation Matter/Project Folder Listing may display Matter Name and default sub-folders (e.g., General, Correspondence, Agreements, Memoranda). The Content Tab may display listing of hyperlinks to content shared by content owners and reviewers. The Email Tab may display a listing of hyperlinks to email threads initiated by content owner(s) and/or reviewer(s). The Legal Research Tab may display hyperlinks to legal research provided by content owner(s). The News Tab may display hyperlinks to news articles provided by content owner(s). The Team Contact Information may display hyperlinks to both law firm attorney(s) and Corporate inside counsel assigned to a matter/project. Clicking on provided hyperlinks may display attorney profile information. The Matter/Project/Content Calendar may provide information in calendar format that may be used to keep track of deliverables and due dates. The History Tab may display connection history and hours worked on content for each team member. In one embodiment, this tab may only be visible to the workspace creator. The Reporting Tab may display history of changes for given content, documents, etc. This tab may also be configured to only be visible to the workspace creator.

### CCA Server (CCAS) Functions

The CCA server (CCAS) resides within the firewall (0421, 0431) of each participating company and/or corporation and is the core component of the CCP (0110) and is generally responsible for the following functions:
database operations, including workspace creation, account creation, access rights, activity logs and connection history;
content flow and distribution to CCP;
connection access and communication with all key systems;
integrated hi-tech security technologies to secure connections;
distribution and execution of all Online services and backend technologies;
integration with native AD controller(s) to create and maintain user accounts internally;
external UserIds (should be based on email address and retrieve IP information upon logon to the CCP (0110) to determine geographic location);
IP addresses (used to control and adhere to Country data privacy restrictions views outside of the restricted Country will not be allowed);
User access, available views, and services (controlled by permissions granted at time user account was created);
GUID for each workspace (supports Country restrictions and association links from other CCAS to the same Workspace to allow the support of unique matter/project information contained on each side of the content owners' and reviewers' domains);
UID for each external UserId (ensures there is only one account created for each user and also allows and support associations to another workspace);
Search requests (completed using the DMS UserId in appropriate repository/repositories).

One skilled in the art will recognize that this list of CCAS functions is non-exhaustive and only exemplary of those possible using the teachings of the present invention.

### Exemplary Online Services

While the present invention may incorporate support for a variety of online services, several are anticipated and include (but are not limited to) the following:
Viewer Services. This service will provide the ability to view content either locally or online;
Editor Services. This service will provide the ability to edit content either locally or online;
Approval Engine. This service will provide the ability to route content to a group of people for approval;
IM Chat. This service will provide ability to chat to others associated with the workspace;
Compare Services. This service will send a request to the Agent Server to provide the ability to compare versions of content and return the results of the request;
Information Rights Management (IRM) Services. This services will send a request to the Agent Server to provide the ability to clean content of all default metadata (as stated above), send the cleaned document to the IRM Server to stamp/encrypt into document the originating source information (such as Author and Company Names, date and time) and information of person who document is being sent to into the property of the document so that it cannot be removed by any metadata cleaning solution and return the clean and stamped file to the CC Agent Server for final delivery;
PDF/Digital Signature Services. This service will send a request to the Agent Server to provide the ability to convert the document to PDF and insert a digital signature into the document. If the document is altered in anyway, the file will know to remove the digital signature and invalidate the file and return the signed file to the Agent Sever for final delivery;
Digital Signature (stand-alone) to support Country acceptance rules.

### Preferred Embodiment System Summary

The present invention preferred exemplary system embodiment anticipates a wide variety of variations in the basic theme of construction, but can be generalized as a document management and bi-directional synchronization system comprising:
(a) content collaboration platform (CCP);
(b) content collaboration agent (CCA); and
(c) computer communication network (CCN);
wherein
the CCP is configured to implement a web-based access portal (WAP) accessible via the CCN by the CCA;
the CCP is configured to accept workspace definition commands (WDC) via the WAP from a Content Owner (COWN);
the CCP is configured to accept Content Reviewer (CREV) definition commands via the WAP from the COWN;
the WDC defines Data Content and/or Documents (DCDS) that are to be used in collaboration between the COWN and the CREV;
the CCP is configured to accept Content Collaboration Access (CCA) controls via the WAP from the COWN that associate the CREV with the DCDS;
the CCP is configured to transmit email communication to the CREV via the CCN to initiate collaboration on the DCDS;
the CCP is configured to embed hyperlinks in the email that permit access to the DCDS by the CREV;
the CCP is configured to permit the CREV to remotely modify a copy of the DCDS via the CCA;
the CCP is configured to synchronize the modifications of the copy by storing the modifications in the DCDS; and
the CCP is configured to prohibit access to the copy after the synchronization is completed.

This general system summary may be augmented by the various elements described herein to produce a wide variety of invention embodiments consistent with this overall design description.

### Preferred Embodiment Method Summary

The present invention preferred exemplary method embodiment anticipates a wide variety of variations in the basic theme of implementation, but can be generalized as a document management method, the method operating in conjunction with a document management system, the system comprising:
(a) content collaboration platform (CCP);
(b) content collaboration agent (CCA); and
(c) computer communication network (CCN);
wherein
the CCP is configured to implement a web-based access portal (WAP) accessible via the CCN by the CCA;
the CCP is configured to accept workspace definition commands (WDC) via the WAP from a Content Owner (COWN);
the CCP is configured to accept Content Reviewer (CREV) definition commands via the WAP from the COWN;
the WDC defines Data Content and/or Documents (DCDS) that are to be used in collaboration between the COWN and the CREV;
the CCP is configured to accept Content Collaboration Access (CCA) controls via the WAP from the COWN that associate the CREV with the DCDS;
the CCP is configured to transmit email communication to the CREV via the CCN to initiate collaboration on the DCDS;
the CCP is configured to embed hyperlinks in the email that permit access to the DCDS by the CREV;
the CCP is configured to permit the CREV to remotely modify a copy of the DCDS via the CCA;
the CCP is configured to synchronize the modifications of the copy by storing the modifications in the DCDS; and
the CCP is configured to prohibit access to the copy after the synchronization is completed.
wherein the method comprises the steps of:
(1) defining a workspace;
(2) defining the CREV identification and characteristics;
(3) associating CREV access to the DCDS through the workspace;
(4) inviting the CREV to collaborate on the DCDS;
(5) generating the copy for the modification by the CREV; and
(6) synchronizing modifications to the copy in the DCDS.

This general method summary may be augmented by the various elements described herein to produce a wide variety of invention embodiments consistent with this overall design description.

### System/Method Variations

The present invention anticipates a wide variety of variations in the basic theme of construction. The examples presented previously do not represent the entire scope of possible usages. They are meant to cite a few of the almost limitless possibilities.

This basic system and method may be augmented with a variety of ancillary embodiments, including but not limited to:
An embodiment wherein the CCN comprises the Internet.
An embodiment wherein the CCN comprises a wireless communication network.
An embodiment wherein the CCN comprises a WiFi wireless communication network.
An embodiment wherein the CCA comprises a mobile communication device (MCD) selected from a group consisting of: laptop computer; tablet computer; personal computer; cellular phone; and smartphone.
An embodiment wherein the WDC comprises a hierarchical Access Rights and Control List (ARCL) to prevent the CREV from unauthorized access to the DCDS.
An embodiment wherein the WDC comprises a hierarchical Access Rights and Control List (ARCL) to restrict editing of the DCDS by the CREV.
An embodiment wherein the WDC comprises a hierarchical Access Rights and Control List (ARCL) to prevent the CREV from uncoordinated modification of the DCDS.
An embodiment wherein the WDC comprises a property list associated with the DCDS.
An embodiment wherein the CCP is configured to permit a plethora of the CREV entities to access and modify the DCDS.
An embodiment wherein the CCP is configured to embed hyperlinks in the email that authenticate the CREV.
An embodiment wherein the CCP is configured to embed hyperlinks in the email that activate software applications on the CCA that are configured to permit access to the copy by the CREV.

One skilled in the art will recognize that other embodiments are possible based on combinations of elements taught within the above invention description.

### Generalized Computer Usable Medium

In various alternate embodiments, the present invention may be implemented as a computer program product for use with a computerized computing system. Those skilled in the art will readily appreciate that programs defining the functions defined by the present invention can be written in any appropriate programming language and delivered to a computer in many forms, including but not limited to: (a) information permanently stored on non-writeable storage media (e.g., read-only memory devices such as ROMs or CD-ROM disks); (b) information alterably stored on writeable storage media (e.g., floppy disks and hard drives); and/or (c) information conveyed to a computer through communication media, such as a local area network, a telephone network, or a public network such as the Internet. When carrying computer readable instructions that implement the present invention methods, such computer readable media represent alternate embodiments of the present invention.

As generally illustrated herein, the present invention system embodiments can incorporate a variety of computer readable media that comprise computer usable medium having computer readable code means embodied therein. One skilled in the art will recognize that the software associated with the various processes described herein can be embodied in a wide variety of computer accessible media from which the software is loaded and activated. Pursuant to In re Beauregard, 35 USPQ2d 1383 (U.S. Pat. No. 5,710,578), the present invention anticipates and includes this type of computer readable media within the scope of the invention. Pursuant to In re Nuijten, 500 F.3d 1346 (Fed. Cir. 2007) (U.S. patent application Ser. No. 09/211,928), the present invention scope is limited to computer readable media wherein the media is both tangible and non-transitory.

### CONCLUSION

A document management system/method allowing coordinated synchronized modifications and secure, scalable, multi-level, and controlled access to Data Content and/or Documents (DCDS) over a computer network between multiple Content Owners and/or Reviewers (CORS) has been disclosed. The system/method is configured to allow any number of CORS to share DCDS using a Collaborative Access Platform (CAP) while retaining complete DCDS integrity/retrieval control using a hierarchical Access Rights and Control List (ARCL) to prevent CORS from uncoordinated DCDS modification and prohibiting local maintenance of DCDS copies after the expiration of a CORS Data Access Session (DAS). Upon termination of a CORS DAS, the system synchronizes modifications to the DCDS and coordinates control information among various CORS to ensure proper return of the DCDS back to its original CORS owner and associated CORS storage location.

1. A document management system comprising:
(a) content collaboration platform (CCP);
(b) content collaboration agent (CCA); and
(c) computer communication network (CCN);
wherein
said CCP is configured to implement a web-based access portal (WAP) accessible via said CCN by said CCA;
said CCP is configured to accept workspace definition commands (WDC) via said WAP from a Content Owner (COWN);
said CCP is configured to accept Content Reviewer (CREV) definition commands via said WAP from said COWN;
said WDC defines Data Content and/or Documents (DCDS) that are to be used in collaboration between said COWN and said CREV;
said CCP is configured to accept Content Collaboration Access (CCA) controls via said WAP from said COWN that associate said CREV with said DCDS;
said CCP is configured to transmit email communication to said CREV via said CCN to initiate collaboration on said DCDS;
said CCP is configured to embed hyperlinks in said email that permit access to said DCDS by said CREV;
said CCP is configured to permit said CREV to remotely modify a copy of said DCDS via said CCA;
said CCP is configured to synchronize said modifications of said copy by storing said modifications in said DCDS; and
said CCP is configured to prohibit access to said copy after said synchronization is completed.

2. The document management system of claim 1 wherein said CCN comprises the Internet.

3. The document management system of claim 1 wherein said CCN comprises a wireless communication network.

4. The document management system of claim 1 wherein said WDC comprises a hierarchical Access Rights and Control List (ARCL) to prevent said CREV from unauthorized access to said DCDS.

5. The document management system of claim 1 wherein said WDC comprises a hierarchical Access Rights and Control List (ARCL) to restrict editing of said DCDS by said CREV.

6. The document management system of claim 1 wherein said WDC comprises a hierarchical Access Rights and Control List (ARCL) to prevent said CREV from uncoordinated modification of said DCDS.

7. The document management system of claim 1 wherein said WDC comprises a property list associated with said DCDS.

8. The document management system of claim 1 wherein said CCP is configured to permit a plethora of said CREV entities to access and modify said DCDS.

9. The document management system of claim 1 wherein said CCP is configured to embed hyperlinks in said email that authenticate said CREV.

10. The document management system of claim 1 wherein said CCP is configured to embed hyperlinks in said email that activate software applications on said CCA that are configured to permit access to said copy by said CREV.

11. A document management method, said method operating in conjunction with a document management system, said system comprising:
(a) content collaboration platform (CCP);
(b) content collaboration agent (CCA); and
(c) computer communication network (CCN);
wherein
said CCP is configured to implement a web-based access portal (WAP) accessible via said CCN by said CCA;
said CCP is configured to accept workspace definition commands (WDC) via said WAP from a Content Owner (COWN);
said CCP is configured to accept Content Reviewer (CREV) definition commands via said WAP from said COWN;
said WDC defines Data Content and/or Documents (DCDS) that are to be used in collaboration between said COWN and said CREV;
said CCP is configured to accept Content Collaboration Access (CCA) controls via said WAP from said COWN that associate said CREV with said DCDS;
said CCP is configured to transmit email communication to said CREV via said CCN to initiate collaboration on said DCDS;
said CCP is configured to embed hyperlinks in said email that permit access to said DCDS by said CREV;
said CCP is configured to permit said CREV to remotely modify a copy of said DCDS via said CCA;
said CCP is configured to synchronize said modifications of said copy by storing said modifications in said DCDS; and
said CCP is configured to prohibit access to said copy after said synchronization is completed.
wherein said method comprises the steps of:
(1) defining a workspace;
(2) defining said CREV identification and characteristics;
(3) associating CREV access to said DCDS through said workspace;
(4) inviting said CREV to collaborate on said DCDS;
(5) generating said copy for said modification by said CREV; and
(6) synchronizing modifications to said copy in said DCDS.

12. The document management method of claim 11 wherein said CCN comprises the Internet.

13. The document management method of claim 11 wherein said CCN comprises a wireless communication network.

14. The document management method of claim 11 wherein said WDC comprises a hierarchical Access Rights and Control List (ARCL) to prevent said CREV from unauthorized access to said DCDS.

15. The document management method of claim 11 wherein said WDC comprises a hierarchical Access Rights and Control List (ARCL) to restrict editing of said DCDS by said CREV.

16. The document management method of claim 11 wherein said WDC comprises a hierarchical Access Rights and Control List (ARCL) to prevent said CREV from uncoordinated modification of said DCDS.

17. The document management method of claim 11 wherein said WDC comprises a property list associated with said DCDS.

18. The document management method of claim 11 wherein said CCP is configured to permit a plethora of said CREV entities to access and modify said DCDS.

19. The document management method of claim 11 wherein said CCP is configured to embed hyperlinks in said email that authenticate said CREV.

20. The document management method of claim 11 wherein said CCP is configured to embed hyperlinks in said email that activate software applications on said CCA that are configured to permit access to said copy by said CREV.

21. A computer usable medium having computer-readable program code means comprising a document management method wherein said method controls a document management system comprising:
(a) content collaboration platform (CCP);
(b) content collaboration agent (CCA); and
(c) computer communication network (CCN);
wherein
said CCP is configured to implement a web-based access portal (WAP) accessible via said CCN by said CCA;
said CCP is configured to accept workspace definition commands (WDC) via said WAP from a Content Owner (COWN);
said CCP is configured to accept Content Reviewer (CREV) definition commands via said WAP from said COWN;
said WDC defines Data Content and/or Documents (DCDS) that are to be used in collaboration between said COWN and said CREV;
said CCP is configured to accept Content Collaboration Access (CCA) controls via said WAP from said COWN that associate said CREV with said DCDS;
said CCP is configured to transmit email communication to said CREV via said CCN to initiate collaboration on said DCDS;
said CCP is configured to embed hyperlinks in said email that permit access to said DCDS by said CREV;
said CCP is configured to permit said CREV to remotely modify a copy of said DCDS via said CCA;
said CCP is configured to synchronize said modifications of said copy by storing said modifications in said DCDS; and
said CCP is configured to prohibit access to said copy after said synchronization is completed.
wherein said method comprises the steps of:
(1) defining a workspace;
(2) defining said CREV identification and characteristics;
(3) associating CREV access to said DCDS through said workspace;
(4) inviting said CREV to collaborate on said DCDS;
(5) generating said copy for said modification by said CREV; and
(6) synchronizing modifications to said copy in said DCDS.

22. The computer usable medium of claim 21 wherein said CCN comprises the Internet.

23. The computer usable medium of claim 21 wherein said CCN comprises a wireless communication network.

24. The computer usable medium of claim 21 wherein said WDC comprises a hierarchical Access Rights and Control List (ARCL) to prevent said CREV from unauthorized access to said DCDS.

25. The computer usable medium of claim 21 wherein said WDC comprises a hierarchical Access Rights and Control List (ARCL) to restrict editing of said DCDS by said CREV.

26. The computer usable medium of claim 21 wherein said WDC comprises a hierarchical Access Rights and Control List (ARCL) to prevent said CREV from uncoordinated modification of said DCDS.

27. The computer usable medium of claim 21 wherein said WDC comprises a property list associated with said DCDS.

28. The computer usable medium of claim 21 wherein said CCP is configured to permit a plethora of said CREV entities to access and modify said DCDS.

29. The computer usable medium of claim 21 wherein said CCP is configured to embed hyperlinks in said email that authenticate said CREV.

30. The computer usable medium of claim 21 wherein said CCP is configured to embed hyperlinks in said email that activate software applications on said CCA that are configured to permit access to said copy by said CREV.
